(19) United States
(12) Patent Application Publication
(10) Pub. No.: US 2024/0417488 A1
(43) Pub. Date: Dec. 19, 2024

(54) CELLULOSE NANOCRYSTAL MODIFICATION FOR ADSORBENTS AND SENSORS

(71) Applicant: AUBURN UNIVERSITY, Auburn, AL (US)

(72) Inventors: Virginia A. Davis, Auburn, AL (US); Maria Soledad Peresin, Auburn, AL (US); Diego Gomez-Maldonado, Auburn, AL (US); Sadat Kamal Amit, Auburn, AL (US); William Robert Ashurst, Auburn, AL (US)

(21) Appl. No.: 18/634,149

(22) Filed: Apr. 12, 2024

Related U.S. Application Data
(60) Provisional application No. 63/472,666, filed on Jun. 13, 2023.

(51) Int. Cl. C08B 15/08; C08J 7/12; C08L 1/04

(52) U.S. Cl. CPC C08B 15/08; C08J 7/12; C08L 1/04; C08L 2203/12; C08L 2203/16

(57) ABSTRACT

Illustrative embodiments of cellulose nanocrystal modification for adsorbents and sensors are disclosed. In at least one illustrative embodiment, a method of modifying cellulose nanocrystals for use in water-based applications may include obtaining sulfated cellulose nanocrystals (CNCs). The method may also include modifying the CNCs with a silane such as an alkylsilane (e.g., an aminoalkyl silane such as 3-aminopropyl-triethoxysilane (APTES)) to obtain modified CNCs. The modified CNCs enable increased hydrolytic stability (e.g., in a resulting structure, such as a film, coating, gel, or fiber(s), formed from the modified CNCs as compared to a structure formed from the unmodified CNCs). Additionally, the method may include using the modified CNCs in a water-based application.

### CROSS-REFERENCE TO RELATED APPLICATION

This application claims the benefit, under 35 U.S.C. § 119(e), of U.S. Provisional Patent Application No. 63/472,666, filed Jun. 13, 2023, the entirety of which is hereby expressly incorporated by reference herein.

### STATEMENT REGARDING FEDERALLY SPONSORED RESEARCH

This invention was made with government support under Award No. 2021-67021-33996 from the National Institute of Food and Agriculture and Grant No. 2050742 from the National Science Foundation. The government has certain rights in the invention.

### BACKGROUND

Cellulose nanocrystals (CNCs) are naturally abundant one-dimensional anisotropic nanomaterials that can be used in numerous commodity and advanced material applications, including those in paper, catalysis, pharmaceutical, and polymer industries. While CNCs can be produced by bacteria, it is more common to extract CNCs from readily-available biomass materials, such as wood, through a sulfuric acid hydrolysis process. However, the sulfuric acid hydrolysis process causes partial substitution of the hydroxyl groups in the CNCs with sulfate half-ester groups, resulting in electrostatic repulsion. As such, structures such as films, coatings, gels, fibers, and the like based on sulfated CNCs quickly disperse in water and, accordingly, have significantly limited use in applications requiring water contact or immersion.

### SUMMARY

According to one aspect, a method for modifying cellulose nanocrystals for use in water-based applications may include obtaining sulfated cellulose nanocrystals (CNCs). The method also includes modifying the CNCs with a silane such as an alkyl silane (e.g., an aminoalkyl silane such as 3-aminopropyl-triethoxysilane (APTES)) to obtain modified CNCs. The modified CNCs enable increased hydrolytic stability (e.g., in a resulting structure or assembly, such as a film, coating, gel, fiber, etc. as compared to a structure made from unmodified CNCs). Additionally, the method includes using the modified CNCs in a water-based application.

Obtaining sulfated CNCs, in some embodiments, includes obtaining the sulfated CNCs through sulfuric acid hydrolysis of woody biomass. While trees, cotton, agricultural and forest waste are common sources, the CNCs can also be extracted from tunicates or produced by bacteria. The sulfated CNCs may be obtained in an aqueous dispersion. Modifying the CNCs may include adding a dispersion of the CNCs to an APTES plus solvent mixture, which may include water and ethanol at a mass ratio of 1.8 to 1. In some embodiments, glacial acetic acid may be added to adjust a pH to 4.0 prior to adding the dispersion of the CNCs to the APTES plus solvent mixture. In modifying the CNCs, the method may include tip sonicating the mixture and magnetically stirring the mixture. One or more centrifugation washes may be performed to separate unreacted APTES and solvent. In combining the CNCs with APTES, the method may include replacing approximately 12.6% of available hydroxyl groups of the CNCs with APTES.

The method may include performing further modification to adjust adsorption characteristics of the modified CNCs, such as for adsorption or sensing of specific analytes. For example, the modified CNCs may be combined with molecularly imprinted polymers. In some embodiments, the modified CNCs may be combined with glutaric anhydride (GA) and one or more antibodies. The method may also include producing a film, a coating, a gel, or one or more fibers with the modified CNCs. The modified CNCs may be used in or added to a device as a film, a coating, a gel, or one or more fibers, for use in the water-based application. In some embodiments, the method may include using the modified CNCs to adsorb molecules in an aqueous medium. The method may include using the modified CNCs to filter one or more environmental toxins, such as carbofuran, from the aqueous medium. In other embodiments, the method may include using the modified CNCs to filter one or more allergens, such as β-lactoglobulin, from the medium. In some embodiments, the method may include using the modified CNCs in a sensor to adsorb one or more analytes, such as carbofuran or β-lactoglobulin to be detected. The method may include using the modified CNCs in a sensor to adsorb one or more biomarkers, such as cancer biomarkers, to be detected.

In another aspect, a device for use in a water-based application may include a component that has a surface. Further, the device includes sulfated cellulose nanocrystals (CNCs) modified with a silane such as an alkyl silane (e.g., an aminoalkyl silane such as 3-aminopropyl-triethoxysilane (APTES)), to increase hydrolytic stability (e.g., in a resulting structure or assembly, such as a film, coating, gel, fiber, etc. as compared to a structure made from unmodified CNCs), connected to or forming at least a portion of the surface of the component. The modified CNCs may be structured as a film, a coating, a gel, or one or more fibers. The component may be a sensor for detecting one or more analytes in an aqueous medium. In some embodiments, the component may be a sensor for detecting an environmental toxin or an allergen. The environmental toxin may be carbofuran. The allergen may be, for example, β-lactoglobulin.

In some embodiments, the device may be a microdevice. In other embodiments, the device (e.g., in which CNC-APTES may be used, such as in a component (e.g., a sensor) thereof) may be a quartz crystal microbalance (QCM) (e.g., with or without dissipation) device, a surface plasmon resonance (SPR) device, a multiparametric SPR device, or other instrumentation for sensing and adsorption. In some embodiments, the component with the modified CNCs may be a filter for adsorbing one or more molecules in an aqueous medium. For example, the component may be a filter for adsorbing an environmental toxin, such as carbofuran, or an allergen, such as β-lactoglobulin, from the aqueous medium. In some embodiments, the CNCs may be further modified with one or more molecularly imprinted polymers (MIPs). In other embodiments, the CNCs may instead by further modified with glutaric anhydride (GA) or glutaraldehyde and one or more antibodies. The further modifications may adjust adsorption characteristics of the CNCs for specific adsorption and sensing of one or more analytes. The CNCs may be modified to adjust adsorption characteristics to enhance adsorption for one or more biomarkers, such as cancer biomarkers.

In another aspect, a method may include obtaining a device that includes sulfated cellulose nanocrystals (CNCs) modified with a silane such as an alkyl silane (e.g., an aminoalkyl silane such as 3-aminopropyl-triethoxysilane (APTES)). The modification of the CNCs increases hydrolytic stability (e.g., of a resulting structure or assembly, such as a film, coating, gel, fiber, etc. as compared to a structure made from unmodified CNCs). The method additionally includes utilizing the device in a water-based application. In some embodiment, the method includes utilizing the device to adsorb molecules in an aqueous medium. For example, the method may include utilizing the device as a filter to adsorb environmental toxins or allergens from the medium. In some embodiments, the method includes utilizing the device as a filter to adsorb the environmental toxin, carbofuran, from the aqueous medium. In other embodiments, the method includes utilize the device as a filter to adsorb the allergen, β-lactoglobulin, from the medium.

The method may include utilizing the device to adsorb one or more analytes to be detected in the aqueous medium. For example, the method may include utilizing the device to adsorb carbofuran, β-lactoglobulin, or a biomarker, such as cancer biomarker. In some embodiments, obtaining the device comprises includes obtaining a microdevice, a quartz crystal microbalance (QCM) (with or without dissipation) device, a surface plasmon resonance (SPR) device, a multiparametric SPR device, or other instrumentation for sensing and adsorption that includes the modified CNCs (e.g., applied to a surface of a component thereof). The method, in some embodiments, may include obtaining a device in which the CNCs are further modified with one or more molecularly imprinted polymers (MIPs) or glutaric anhydride (GA) or glutaraldehyde and one or more antibodies to adjust adsorption and detection characteristics of the CNCs (e.g., to enable specific adsorption and sensing of one or more target analytes).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIGS. 1-3 are simplified block diagrams of at least one embodiment of a method for modifying cellulose nanocrystals (CNCs) for use in water-based applications;

FIG. 4 is a simplified block diagram of at least one embodiment of device that includes CNCs that have been modified based on the method of FIGS. 1-3, for use in a water-based application;

FIG. 5 is a diagram of a chemical reaction to modify CNCs with APTES;

FIG. 6 is an AFM scan of a dried CNC dispersion;

FIG. 7 is graph of an X-ray diffraction spectra of CNCs;

FIG. 8 is a conductometric titration plot of dispersion conductivity versus added volume of NaOH;

FIG. 9 is representative thermal gravimetric analysis (TGA) plot of CNCs using an air atmosphere;

FIG. 10 is a graph of ATR-FTIR spectra of CNCs and CNC-APTES;

FIG. 11 is a table providing a characterization summary of CNC and CNC-APTES;

FIG. 12 is a table of variables and values for determining surface hydroxyl groups;

FIGS. 13-14 are graphs of a hydrodynamic radius distribution of CNCs and CNC-APTES;

FIG. 15 is a set of images indicative of cross-polarized transmitted light microscopy, height, and phase scans of CNC-APTES;

FIG. 16 is a set of images of transmitted cross-polarized optical microscopy images of aqueous CNC dispersions;

FIG. 17 is a set of images of film applicators;

FIG. 18 is a set of images of cross-polarized optical microscopy images of shear-cast CNCs and CNC-APTES films;

FIG. 19 is a set of images indicating structural stability of CNC and CNC-APTES films in water;

FIG. 20 is a set of graphs representing the hydrolytic stability of CNC and CNC-APTES films;

FIG. 21 is a stress strain graph indicating mechanical properties of shear cast CNC and CNC-APTES films;

FIG. 22 is a graph representing a comparison of mechanical properties of CNC and CNC-APTES films;

FIG. 23 is table indicating mechanical properties of CNC-APTES films before and after water immersion;

FIG. 24 is a set of sensorgrams representing interactions of carbofuran with CNC and CNC-APTES coated Au sensors;

FIG. 25 is a set of sensorgrams representing interactions of carbofuran with CNC and CNC-APTES coated Au sensors;

FIG. 26 is a set of QCMD sensorgrams representing interactions of carbofuran with CNC and CNC-APTES coated Au sensors;

FIG. 27 is a table representing nonspecific molecular interaction of carbofuran with CNC and CNC-APTES;

FIG. 28 is a set of images representing hydrolytic stability testing of shear cast films; and

FIG. 29 is a set of images depicting tensile testing of shear cast films.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The native hydroxyl groups of CNCs make them inherently hydrophilic. However, the use of sulfuric acid to extract CNCs from biomass (e.g., woody biomass) results in the partial substitution of the hydroxyl groups with sulfate half-ester groups. The resulting electrostatic repulsion causes sulfated CNCs to readily disperse in water. The ready dispersion of sulfated CNCs in water enables the use of aqueous processing to produce CNCs films, but also makes the resulting films inherently unstable in water. Research has been performed to modify the surface chemistry of CNCs to improve their suitability for various applications. For example, CNC modification has been performed using polymers such as polylactic acid, polyphenols, and chitosan, surfactants such as cetyltrimethylammonium bromide (CTAB) and other compounds, including isocyanates, castor oil, and butyric anhydride. Much of the research has focused on increasing the hydrophobicity of CNCs to facilitate their dispersion in polymers and organic solvents. Other research has focused on modifying CNCs to increase the stability of CNC films in different solvents. For example, research has been perform on enhancing CNC film stability in solvents while retaining their chiral nematic ordering for photonic applications. Glutaraldehyde may be utilized to create cross-linked films that are stable in a range of solvents, including water and toluene. A combination of glutaraldehyde and poly(vinyl alcohol) may enhance both film stability and toughness.

Silylation is a functionalization method that may be used to enhance hydrophobicity, thermal properties, and interfacial interaction with other materials. Silanes known as silylating agents include, but are not limited to, alkyl silanes of the formula RSi(X)₃. In one embodiment, R of the formula RSi(X)₃ refers to an optionally substituted alkyl group (e.g., C₁-C₆ alkyl), and each X independently refers to a hydrolysable group, such as an alkoxy group (e.g., C₁-C₆ alkoxy, including methoxy and ethoxy) or a halogen group (e.g., fluoro, chloro, bromo, or iodo). The alkyl group (R) may be unsubstituted or substituted with one or substituents such as amino (—NH₂), halo, alkoxy, hydroxy (—OH), thio (—SH), cyano (—CN), isocyano (—NC), and isothiocyanato (—NCS) to introduce functional groups for further functionalization reactions.

Illustrative alkyl silanes including an unsubstituted alkyl group include methyltrialkoxysilane, ethyltrialkoxysilane, n-propyltrialkoxysilane, and the like. Illustrative alkyl silanes including a substituted alkyl group include aminoalkyl silanes (e.g., aminoalkyl-trialkoxysilane and aminoalkyl-trihalosilane), haloalkyl silanes (e.g., haloalkyl-trialkoxysilane and haloalkyl-trihalosilane), alkoxyalkyl silanes (e.g., alkoxyalkyl-trialkoxysilane and alkoxyalkyl-trihalosilane), hydroxyalkyl silanes (e.g., hydroxyalkyl-trialkoxysilane and hydroxyalkyl-trihalosilane), thioalkyl or mercaptoalkyl silanes (e.g., mercaptoalkyl-trialkoxysilane and mercaptoalkyl-trihalosilane), cyanoalkyl silanes (e.g., cyanoalkyl-trialkoxysilane and cyanoalkyl-trihalosilane), and the like. In one embodiment, the silane is an alkylsilane such as an aminoalkyl silane (e.g., 3-aminopropyl-triethoxysilane).

With regard to the silylation of CNCs, 3-isocyanatepropyltriethoxysilane (IPTS)-modified CNCs may be used for reinforcing silicon rubber, 3-mercaptopropyltrimethoxysilane (MPTMS, 95%)- and n-propyltriethoxysilane (PTS)-modified CNCs may be used for froth floatation, methyltrimethoxysilane-modified CNCs may be used as a flame retardant material, n-propyltriethoxysilane (PTS)- and 3-aminopropyl-triethoxysilane (APTES)-modified bifunctionalized CNCs may be used for quartz microfloatation. APTES may be used as a silylation agent due to its reactivity and ability to introduce amino functional groups for further functionalization reactions. For example, APTES-GA (glutaraldehyde) chemistry may be used to immobilize proteins and/or other biomolecules on nanomaterial surfaces. A significant challenge with APTES modification of nanomaterials is that the ability of APTES to cross-link with itself can result in nanomaterial aggregation. The nanomaterial aggregation may be mitigated by running reactions at relatively dilute concentrations. Additionally, prolonged reaction time may cause hydrolysis that results in condensed form or reduced stability. The orientation of molecules on the surface is important to control with high precision.

With regard to sulfated CNCs, an aminoalkyl silane (e.g., APTES) reacts with surface hydroxyl groups, resulting in a surface-bound amino functionalized layer. Silylated CNCs hydrogels may be produced using 3-aminopropyltriethoxysilane (APTES, C₉H₂₃NO₃Si≥98%). CNC-APTES exhibits enhanced thermal stability compared to the initial sulfated CNC. Further, APTES-modified CNCs may be used as immobilization support for nanoparticles, coating agents to alter the interphase interaction, and/or in nanocomposite membranes for metal removal or dye adsorption. Additionally, glutaric anhydride (GA) may be used to link CNC-APTES that has been modified with one or more antibodies for cancer biomarker detection. The resulting CNC-APTES-antibody films exhibit sufficient hydrolytic stability to enable prolonged quartz crystal microbalance with dissipation (QCMD) testing using phosphate-buffered saline as the medium. The enhanced hydrolytic stability, mechanical properties, and adsorption abilities of structures or assemblies (e.g., films, coatings, fibers, gels, etc.) made from CNCs modified with APTES are described herein, in connection with methods and devices for using the modified CNCs for water-based applications that are not feasible with sulfated CNCs that have not been modified APTES.

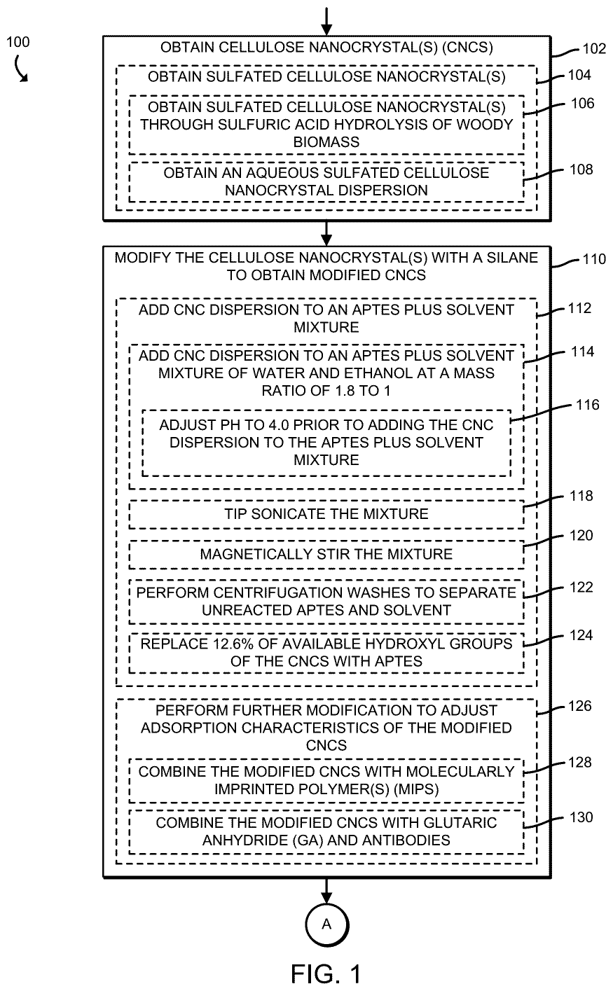

FIGS. 1-3 and the accompanying description set out embodiments of a method for modifying cellulose nanocrystals (CNCs) for use in water-based applications. A detailed description of an implementation of the method is provided afterwards. Referring now to FIG. 1, the method 100 for modifying cellulose nanocrystals (CNCs) for use in water-based applications begins with obtaining one or more cellulose nanocrystals, as indicated in block 102. As indicated in block 104, in the illustrative embodiment, obtaining CNCs involves obtaining sulfated CNCs. The sulfated CNCs may be obtained through a sulfuric acid hydrolysis of woody biomass, as indicated in block 106. Further, and as indicated in block 108, obtaining sulfated CNCs, in the illustrative embodiment, involves obtaining an aqueous sulfated nanocrystal dispersion.

Continuing the method 100, a subsequent operation involves modifying the cellulose nanocrystals (e.g., from block 102) with a silane such as an alkylsilane (e.g., an aminoalkyl silane such as 3-aminopropyl-triethoxysilane (APTES)), as indicated in block 110. Modifying the CNCs (e.g., sulfated CNCs) with a silane (e.g., APTES) increases the hydrolytic stability of a resulting structure (e.g., a film, coating, gel, fibers, etc.) formed from the modified CNCs compared to a structure formed the unmodified CNCs (e.g., from block 102). As indicated in block 112 modifying the CNCs, in the illustrative embodiment, includes adding the CNCs dispersion (e.g., the aqueous sulfated CNCs dispersion from block 108) to an APTES plus solvent mixture. In at least some embodiments, the operation involves adding the CNC dispersion to an APTES plus solvent mixture of water and ethanol at a mass ratio of 1.8 to 1, as indicated in block 114. Further, in some embodiments, the method 100 includes adjusting the pH to 4.0 (e.g., with glacial acetic acid) prior to adding the CNC dispersion to the APTES plus solvent mixture, as indicated in block 116.

The method 100 may also include tip sonicating the mixture (e.g., for approximately 3 minutes, with parameters of 90 kJ/g, 750 W, 30% amplitude)), as indicated in block 118. Further, the method 100 may include magnetically stirring the mixture (e.g., for approximately 2 hours), as indicated in block 120. In some embodiments, the method 100 may include performing one or more centrifugation washes (e.g., two washes, with parameters of 2200 g, 60 minutes) to separate unreacted APTES and solvent, as indicated in block 122. In at least some embodiments, the resulting sediment may vary from 2.0 to 2.2 vol % (3.2 to 3.5 wt %). In performing the operations, in the illustrative embodiment, approximately 12.6% of available hydroxyl groups of the CNCs (e.g., sulfated CNCs) are replaced with APTES, as indicated in block 124.

In some embodiments, the method 100 may include performing further modification to adjust the adsorption characteristics of the modified CNCs (e.g., of the CNC-APTES), as indicated in block 126. Doing so may enable the modified CNCs to adsorb specific molecules (e.g., analytes) for use in specific sensing applications, as described in more detail herein. As indicated in block 128, performing further modification may include combining the modified CNCs (e.g., CNC-APTES) with one or more molecularly imprinted polymers (MIPs). For example, MIPs may be synthesized with a template molecule (e.g., carbofuran), methacrylic acid (MAA) (25 wt %) as functional monomer, poly(ethylene glycol) diacrylate (PEGDA) (50 wt %) as crosslinker, 2,2′-Azobis(2-methylpropionitrile) (AIBN) (0.6 wt %) as initiator, and dimethyl sulfoxide (DMSO) (16 wt %) as solvent. The mixture may be uniformly mixed with the aid of vortex mixing (e.g., for one minute) and bath sonication (e.g., for 15 minutes). Argon may be bubbled through the mixture (e.g., for 10 minutes) before sealing the gas inlet and purging outlet to maintain an inert atmosphere. In some embodiments, the mixture may be precured (e.g., at 65° C. in a water bath) until a gel is formed (e.g., for application onto CNC-APTES). In some embodiments, the method 100 may include combining the modified CNCs (e.g., CNC-APTES) with glutaric anhydride (GA) and one or more selected antibodies, as indicated in block 130. The glutaric anhydride (GA) may operate as an organo-linker for antibody immobilization. The antibodies, in some embodiments, may be cancer-related antibodies (anti alpha fetoprotein (antiAFP), anti prostate specific antigen (antiPSA), and/or anti carcinoembryonic antigen (antiCEA)). The modification may be performed in aqueous dispersions or by applying the modifications to films.

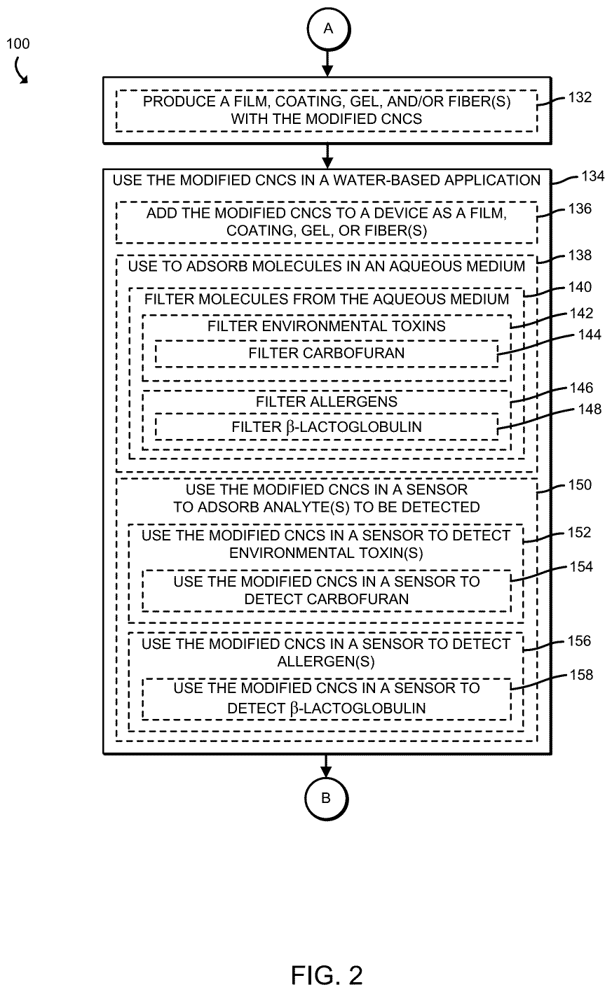

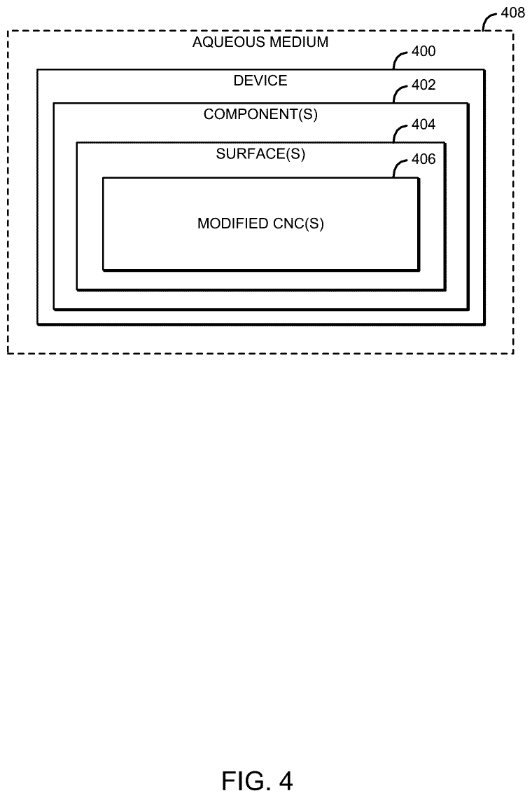

Referring now to FIG. 2, the method 100 may include producing a film, coating, gel, or one or more fibers with the modified CNCs, as indicated in block 132. In the illustrative embodiment, the method 100 advances to block 134 in which the modified CNCs are used in a water-based application. In some embodiments, the modified CNCs may be used in or added to a device 400 (e.g., to a surface 404 of one or more components 402 of the device 400) as a film, a coating, a gel, or one or more fibers, as indicated in block 136. Referring briefly to FIG. 4, a device 400, which may be a filter device, a sensor device (e.g., a handheld device, a microdevice, a quartz crystal microbalance with dissipation (QCMD) device, a surface plasmon resonance (SPR) device, etc.)) includes one or more components 402 (e.g., parts, such as a sensor element), each of which has one or more surfaces 404. In the illustrative embodiment, the modified CNCs 406 (e.g., from block 110) are applied to or form at least a portion of one or more surfaces 404 of the device 400. In operation, all or a portion of the device 400 (e.g., at least the portion with the modified CNCs 406) may be exposed to (e.g., immersed in) an aqueous medium (e.g., a medium containing water and potentially other molecules), in which a structure or assembly (e.g., film, coating, gel, fiber(s), etc.) formed from the modified CNCs 406 exhibit significantly increased hydrolytic stability over a structure formed from unmodified sulfated CNCs. The modified CNCs 406 may additionally exhibit adsorption capabilities for use in water-based sensing and/or filtering applications as described in more detail herein.

As indicated in block 138, the method 100 may include using the modified CNCs 406 to adsorb molecules in an aqueous medium (e.g., the aqueous medium 408). Using the modified CNCs 406 to adsorb molecules in an aqueous medium may include using the modified CNCs 406 to filter (e.g., remove) molecules from the aqueous medium 408, as indicated in block 140. The molecules may be molecules associated with a “contaminant of emerging concern” as defined by the Environmental Protection Agency (EPA) (e.g., as described at https://apps.ecology.wa.gov/publications/SummaryPages/2110006.html). The method 100 may include using the modified CNCs to filter environmental toxins from the aqueous medium 408, as indicated in block 142. For example, and as indicated in block 144, method 100 may include using the modified CNCs 406 to filter carbofuran from the aqueous medium 408.

In some embodiments, the method 100 may include using the modified CNCs 406 to filter allergens from the aqueous medium 408, as indicated in block 146. For example, and as indicated in block 148, the modified CNCs 406 may used to filter (e.g., remove) β-lactoglobulin from the medium 408. β-lactoglobulin is a food allergen that can cause allergy or digestion problems for infants or young children. As indicated in block 150, the modified CNCs 406 may be used to adsorb one or more analytes to be detected (e.g., in the aqueous medium 408). The analytes, in some embodiments, may be any contaminant of emerging concern, as defined by the Environmental Protection Agency (EPA). In particular, in some embodiments, the analytes may be one or more pesticides or environmental toxins. The method 100 may include using the modified CNCs 406 to detect one or more environmental toxins in the aqueous medium 408, as indicated in block 152. For example, the CNCs 406 may be used to detect carbofuran, as indicated in block 154. As indicated in block 156, the modified CNCs 406 may used to detect one or more allergens in the aqueous medium 408. For example, and as indicated in block 158, the modified CNCs 406 may be used to detect β-lactoglobulin in the medium 408.

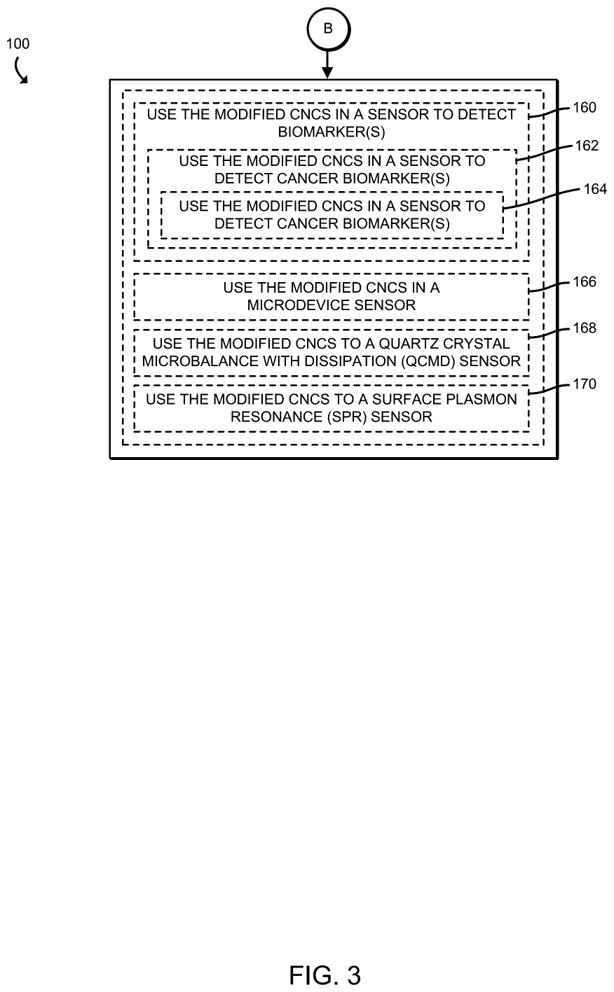

Referring now to FIG. 3, continuing the method 100, in some embodiments, the modified CNCs 406 may be used to detect one or more biomarkers (e.g., measurable substances that are indicative of a disease, infection, or other condition of an organism) in the aqueous medium 408, as indicated in block 160. For example, and as indicated in block 162, the method 100 may include using the modified CNCs 406 in a sensor to detect one or more cancer biomarkers. That is, in some embodiments, the modified CNCs 406 may be used in a sensor to detect one or more cancer antigens (e.g., alpha-fetoprotein, prostate-specific antigen, and/or carcinoembryonic antigen), as indicated in block 164. As indicated in block 166, the method 100 may include using the modified CNCs 406 in a microdevice sensor (e.g., the device 400 or a component 402 of the device 400 may be a microdevice sensor, such as one or more of the microdevices disclosed in U.S. Pat. Nos. 9,353,313 and 9,890,259, which are incorporated herein by reference). Additionally or alternatively, and as indicated in block 168, the modified CNCs 406 may be used in a quartz crystal microbalance with dissipation (QCMD) sensor (e.g., the device 400 or a component 402 of the device 400 may be a QCMD sensor). In some embodiments, and as indicated in block 170, the modified CNCs 406 may be used in a surface plasmon resonance (SPR) sensor (e.g., the device 400 or a component 402 of the device 400 may be an SPR sensor).

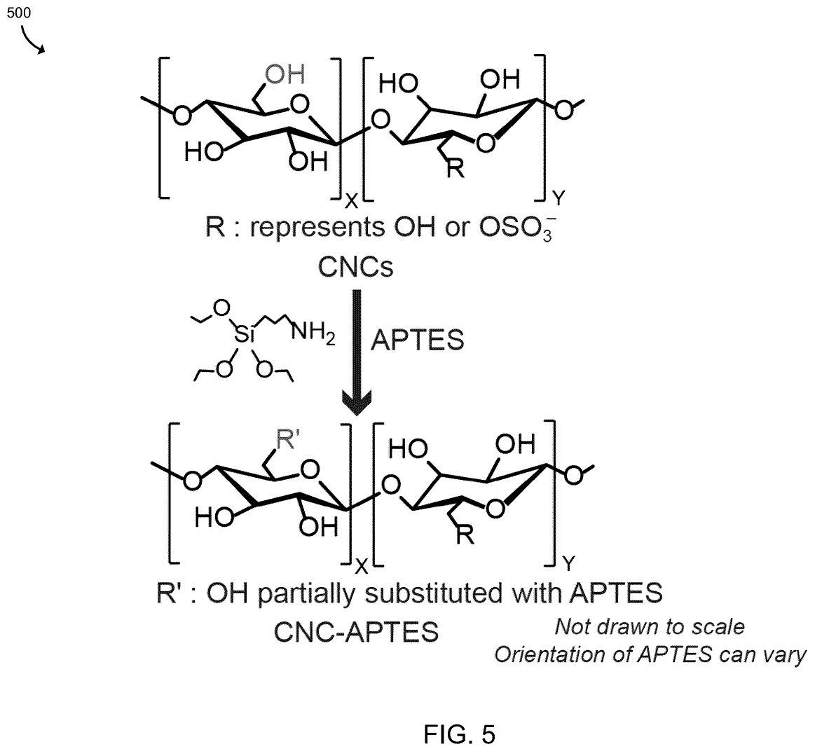

In an example implementation of the method 100, CNCs extracted from woody biomass (CelluForce NCC Dispersion NCV-100, Montreal, Canada) were modified with APTES. A schematic 500 of the APTES functionalization of the sulfated anhydroglucose unit is shown in FIG. 5. The initial and APTES-modified CNCs were characterized using attenuated total reflectance Fourier transform infrared spectroscope (ATR-FTIR), ultimate analysis, inductively coupled plasma mass spectroscopy (ICP-MS), X-ray diffraction (XRD), and thermogravimetric analysis (TGA). The particle size, ζ-potential, charge, and conductivity were also measured.

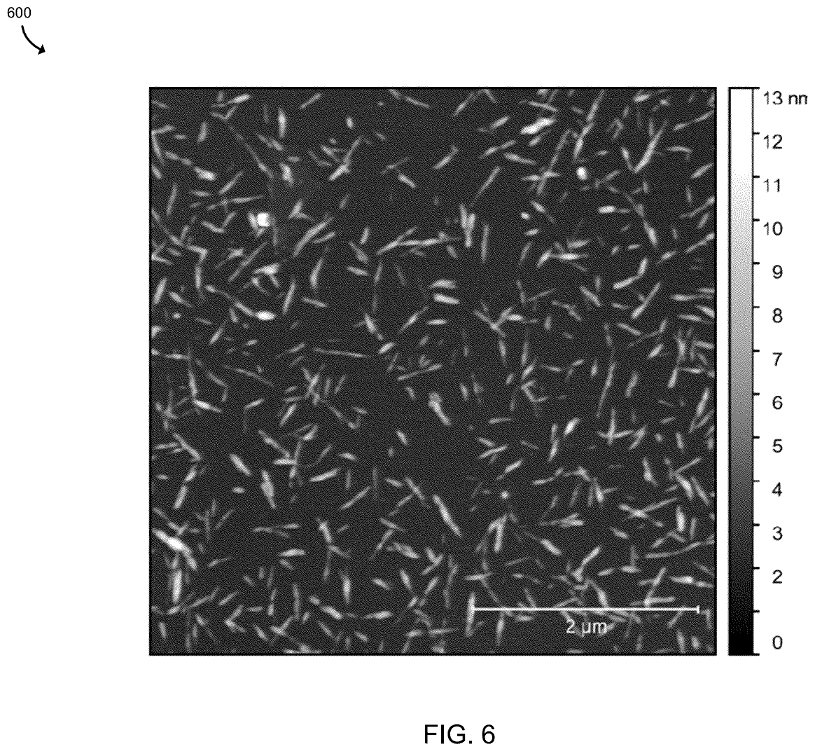

Regarding the CNCs dimensions, the length and height of individual CNCs were determined using an Anton Paar TOSCA 400 atomic force microscope (AFM). Samples were prepared by drop-casting a 15 ppm CNC dispersion onto a cleaved mica surface coated with poly-L-lysine. The substrate was rinsed with ultrapure water after 3 minutes, and oven dried at 80° C. overnight. The samples were scanned in tapping mode, and Gwyddion was used to measure the dimensions by leveling the data and considering tip convolution. The length, height, and width of CNCs were 160±36 nm, 3±0.8 nm, and 57±9 nm, respectively. A representative CNCs AFM image 600 is shown in FIG. 6. Specifically, the image 600 represents an AFM scan of a dried 15 ppm CNC dispersion on mica surface coated with poly-L-lysine. The scale bar represents 2 μm.

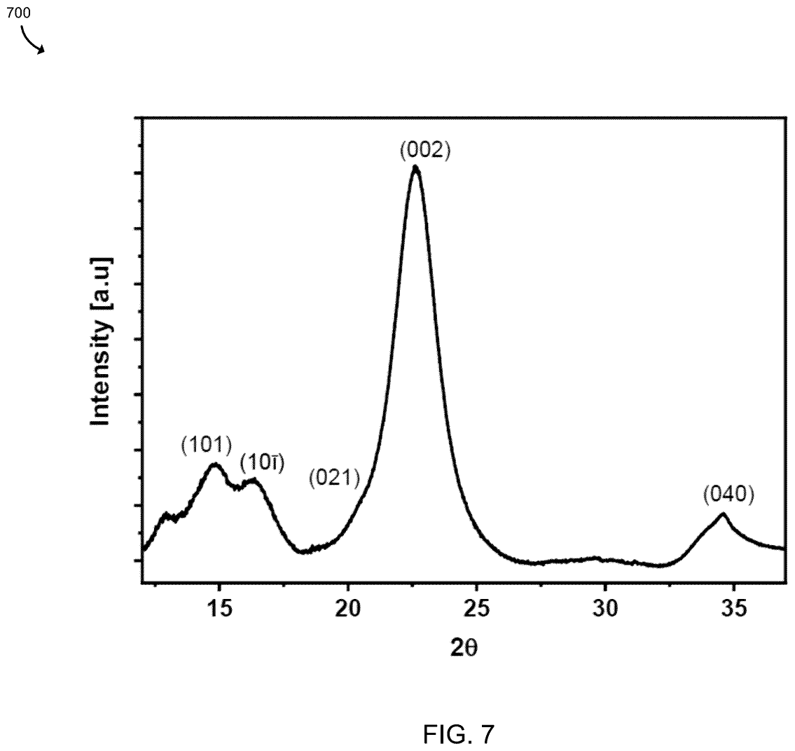

Regarding the crystallinity index, X-ray diffraction (XRD) was performed in an AXRD powder diffraction system (Proto Manufacturing) using Cu Kα (0.15418) radiation generated at 40 kV and 30 mA in the range of 12 to 36 degrees for 2θ in 0.05-degree steps with a dwell time of 15 seconds. A representation 700 of the XRD spectra of CNCs with five distinct crystalline peaks is shown in FIG. 7. The crystallinity index was determined from the XRD spectra by using a deconvolution method with curve fitting to find the areas under crystalline peaks and amorphous peaks along with Equation 1, shown below, in which A_{c} is the total crystalline area and Aₐₘ is the total amorphous area.

$${CI}_{R} ( \% ) = \frac{{A}_{C}}{{A}_{C} + {A}_{a m}} \times 100. \qquad ( Equation 1 )$$

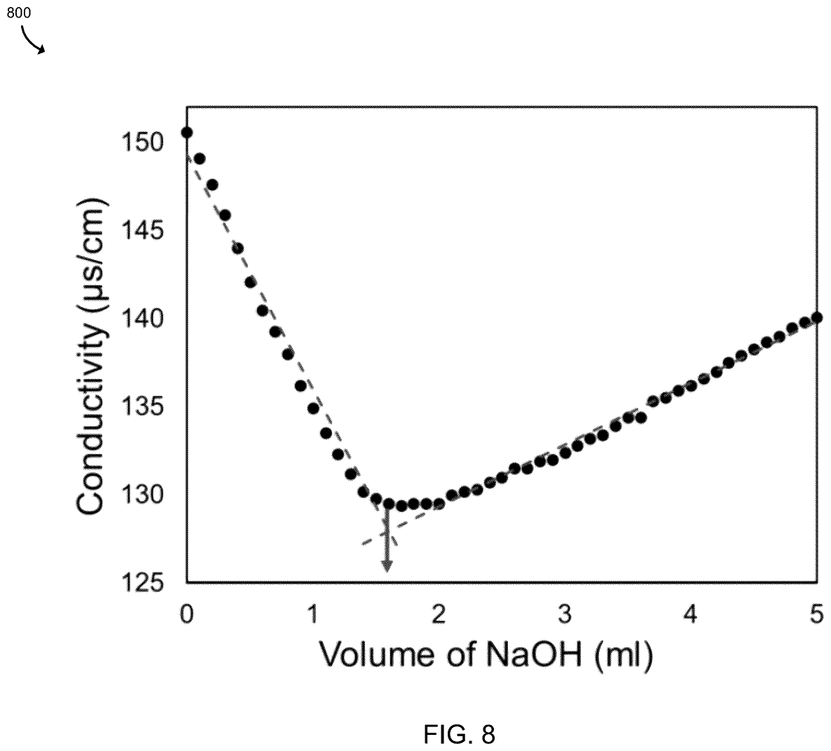

Regarding sulfate half ester determination, the as received CNC gel was diluted to 1.5 wt % and dialyzed extensively with ultrapure water by placement of the dispersion inside Spectra/Por 4 dialysis membrane and submersion into ultrapure water with gentle magnetic stirring. The water was changed every 12 hours until the dialyzed water pH became equal to the pH of pure water (pH=6.4). DOWEX Marathon-C, a strong acid cation exchange resin, was used to prepare a column and thoroughly rinsed with ultrapure water. The dispersion was passed through the ion exchange column three times to protonate the CNCs. Next a dispersion containing 150 mg of protonated CNCs (H-CNCs) was diluted with ultrapure water to result in a 200 mL dispersion. 2 mL of 0.1 M NaCL solution was added to increase the initial conductivity. Then, the dispersions were titrated with 10 mM NaOH using a Symphony B30PCI titrator system to determine the equivalent point, as shown by the plot 800 (a conductometric titration plot of dispersion conductivity versus added volume of NaOH) in FIG. 8. The sulfate half ester content was found to be 125 mmol R—OSO₃⁻ per kilogram of CNCs (0.4 wt % S).

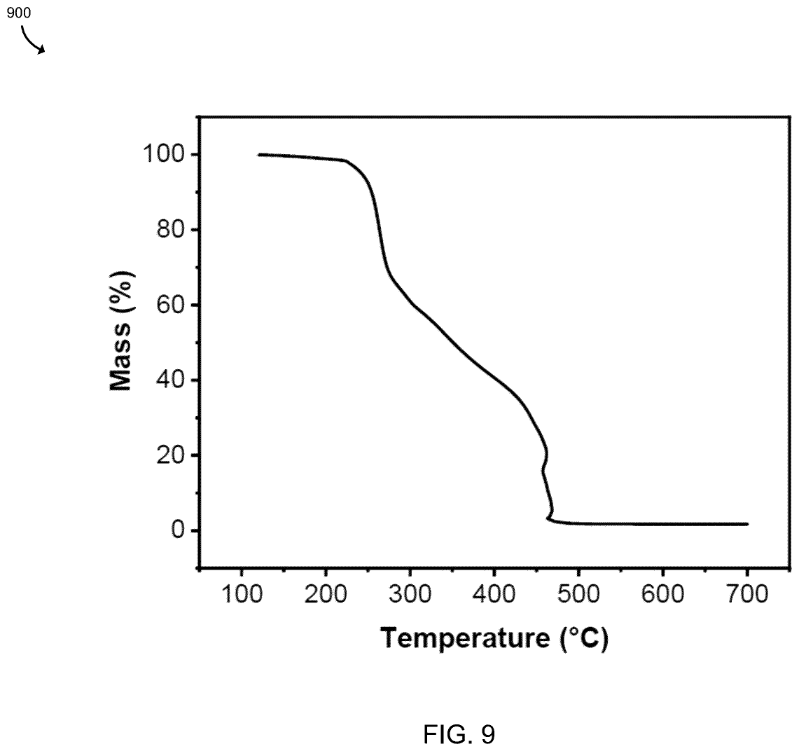

Charge density was determined by colloidal titration using a Chemtrac Laboratory Charge Analyzer. CNCs were diluted to form a 0.5 wt % aqueous dispersion, and 25 ml p-DADMAC (0.001N) was added to 15 ml of the CNC dispersion. The mixture was well mixed and centrifuged to remove any aggregates. 10 ml supernatant was collected and titrated against 0.001N PVSK in a charge analyzer. The charge density was calculated based on the volume required to make the dispersion charge neutral. Regarding thermal stability, a TA Instruments (New Castle, DE) TGA Q50 was used to determine the dispersion concentrations and thermal decomposition analysis of CNCs and CNC-APTES under Argon. The thermal degradation temperature was determined based on 5% mass loss after isothermal hold for 45 minutes at 120° C. A representative thermal gravimetric analysis (TGA) plot 900 of CNCs using an air atmosphere is shown in FIG. 9.

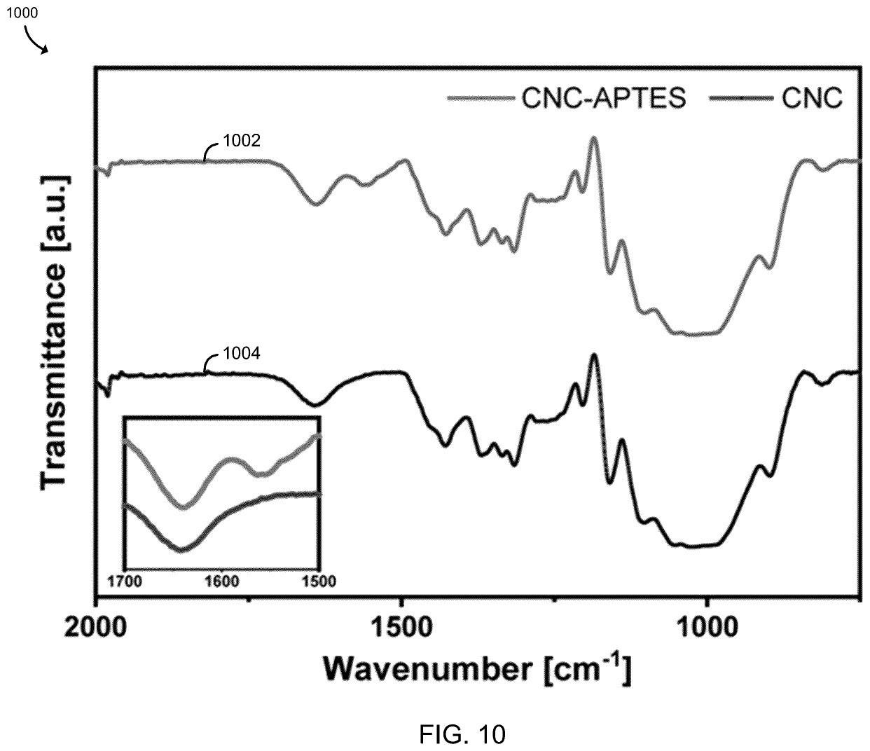

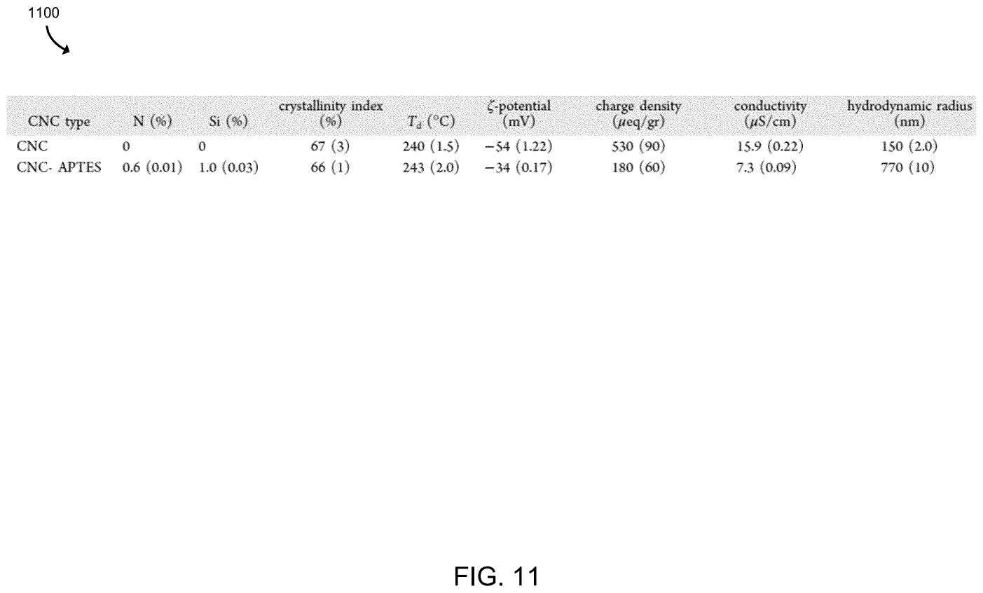

The presence of APTES was qualitatively confirmed based on the presence of primary amine N—H bending (1650-1580 cm⁻¹) vibrations in the ATR-FTIR spectra 1000 shown in FIG. 10, in which the plot 1002 represents CNC-APTES and the plot 1004 represents CNC. Additional characterization results are listed in the table 1100 of FIG. 11, in which numbers represented in parenthesis are standard error calculated based on a minimum of three runs. Quantifying the degree of substitution on CNCs is a challenge due to the relatively low number of surface hydroxyl groups available for functionalization and the need to use multiple methods, all of which have some experimental limitations. In the present implementation, the degree of substitution (DS) was calculated based on the number of hydroxyl groups available on the surface of CNCs and the weight percent of nitrogen determined using ultimate analysis. The number of available hydroxyl groups on a CNC's surface was determined based on the model represented by Equation 2, shown below, in which L₁, L₂, and L₃ define the height, width, and length of the CNCs, respectively, d(110) and d(11̅0̅) are the horizontal and vertical unit cell dimensions of CNCs, respectively, n₁ and n₂ are the number of primary —OH groups facing (110) and (11̅0̅) planes in the unit cell, respectively, ρ is the density, c is the unit cell dimension, and N_{A} stands for the Avogadro's number.

$${N}_{O H} = \frac{{n}_{1} + {n}_{2}}{ρ {N}_{A} {L}_{1} {L}_{2} c} ( \frac{{L}_{1} + {L}_{2}}{{d}_{( 110 )}} + \frac{{L}_{1} + {L}_{2}}{{d}_{( 1 \overline{1} 0 )}} ) + 2 {( ρ {N}_{A} {L}_{3} {d}_{( 110 )} {d}_{( 1 \overline{1} 0 )} )}^{- 1} . \qquad ( Equation 2 )$$

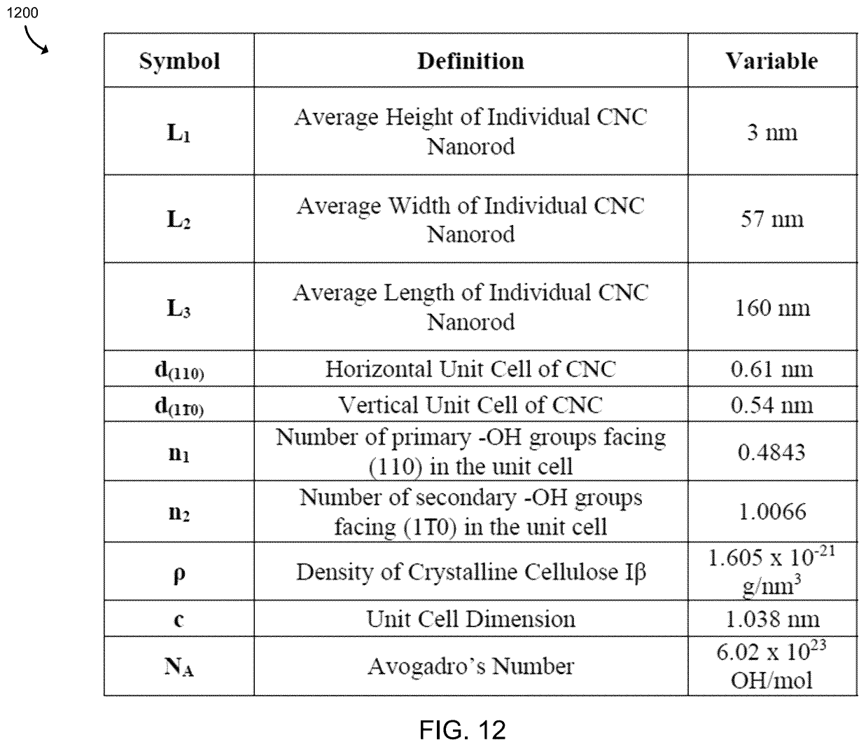

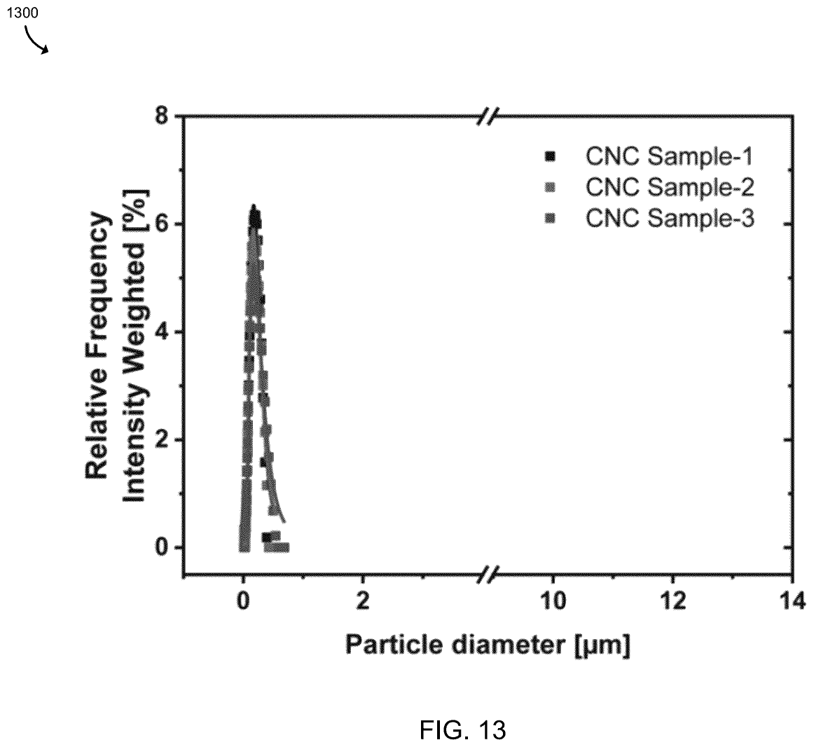

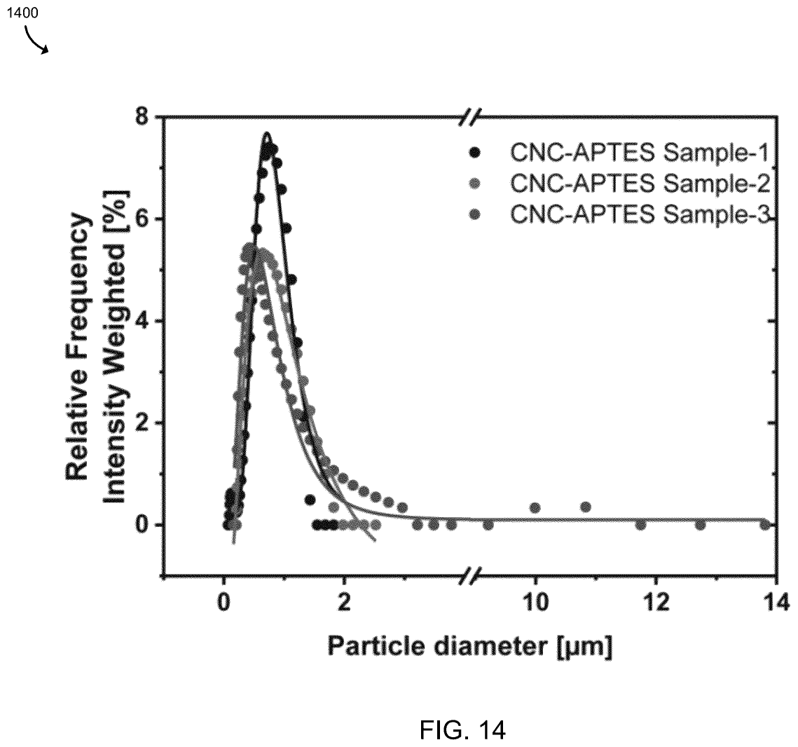

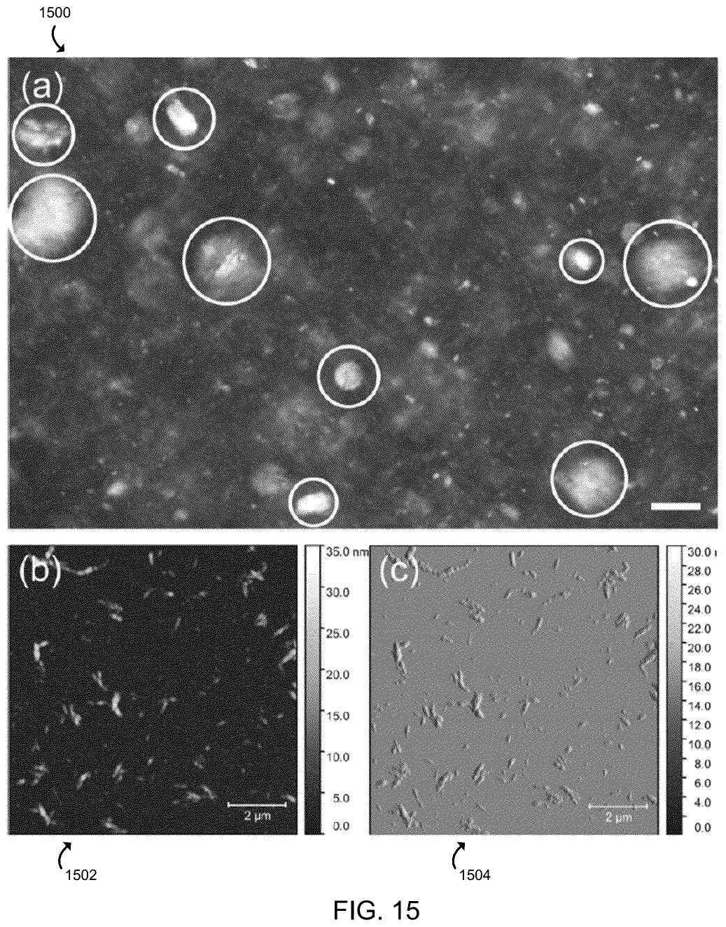

The parameters used in the equation (Equation 2) are given in the table 1200 of FIG. 12. Based on Equation 2, the average number of available hydroxyl groups on a pristine CNC surface is 1.9 mmol/g, but some of these are converted to sulfate half-ester groups during the acid hydrolysis used for CNC extraction. Based on the conductometric titration shown in FIG. 8, the sulfate half-ester content was found to be 0.13 mmol/g (0.4 wt %). Ultimate analysis showed the nitrogen content was 0.6 wt %, and inductively coupled mass spectrometry (ICP-MS) showed the amount of silican was 1 wt %. The difference between the resulting 0.9:1.0 N/Si atomic ratio and the expected 1:1 ratio is attributed to experimental error. Based on these results, the degree of —OH substitution by APTES was DS=12.6%. This degree of substitution did not significantly affect the crystallinity index, as measured by X-ray diffraction (XRD) or the thermal degradation temperature, as measured by thermal gravimetric analysis (TGA) in FIG. 9. However, the substitution of —OH groups with APTES decreased the charge density and the conductivity of the CNC dispersion, as indicated in the table 1100 of FIG. 11. APTES modification also decreased the colloidal stability of CNCs in water. The ζ-potential increased from −54 to −34 mV. While −34 mV still indicates colloidal stability, there was a marked change in the hydrodynamic radius measurements. The measured hydrodynamic radius is a function of the volume swept by the particle. For rod-like colloids, this generally relates to the largest dimension. For CNC, the average hydrodynamic radius was consistently around 150 nm, which is consistent with the 160±36 nm average length measured by AFM. Additionally, the hydrodynamic radius measurements had a log-normal size distribution as indicated in the plots 1300, 1400 of FIGS. 13 and 14. The log-normal size distribution is consistent with the expected CNC polydispersity. However, CNC-APTES had a much larger average hydrodynamic radii ranging between 420 and 700 nm between samples. Some particles even measured over 10 μm. This is largely attributed to end-to-end cross linking of CNCs by APTES, although AFM height images 1500, 1502, 1504 shown in FIG. 15 also showed some side-to-side aggregation. The image 1500 illustrates cross-polarized transmitted light microscopy of a 1.7 vol % (2.8 wt %) CNC-APTES dispersion. The aggregates are marked with white circles and appear larger than their actual size due to them not all being in the same focal plane. The scale bar represents 50 μm. The image 1504 represents an AFM height scan of CNC-APTES (15 ppm) dried on mica substrate. The scale bar represents 2 μm. The image 1506 represents an AFM phase scan of the CNC-APTES (15 ppm) dried on the mica substrate. Some aggregates were large enough to distort cross-polarized optical microscopy images. Previous work showed that CNC-APTES aggregates became larger and more numerous with increasing reactant concentration, which could result in less available surface area for further modification and nonuniform macroscale properties. The CNC and APTES ratio used in the present implementation was based on research that indicated sufficient colloidal stability for further surface reaction in the dispersion phase.

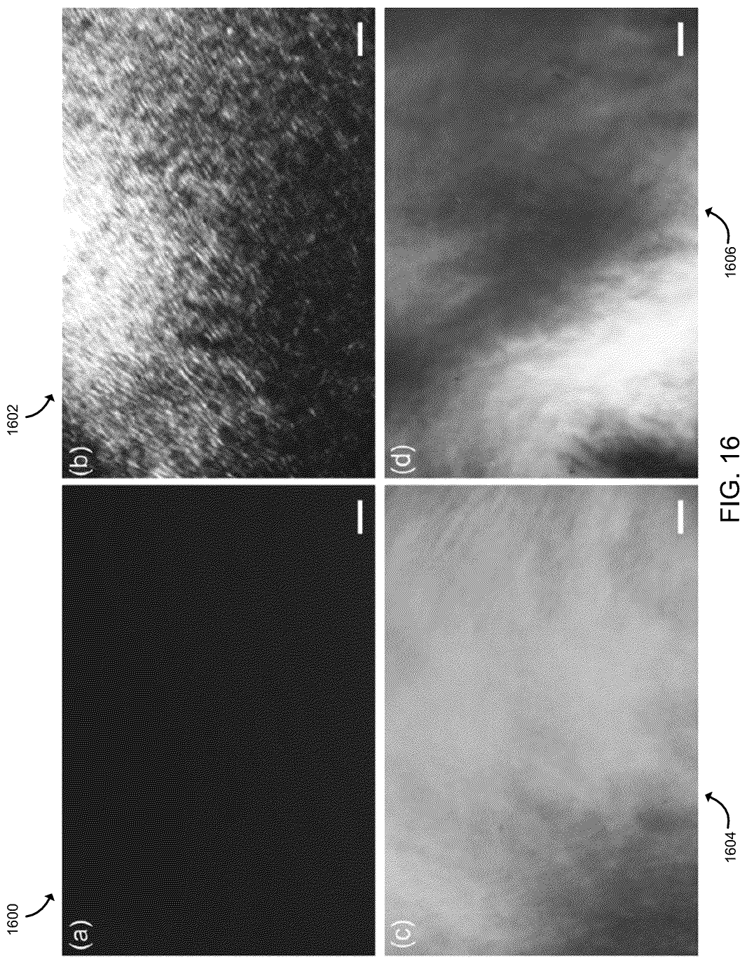

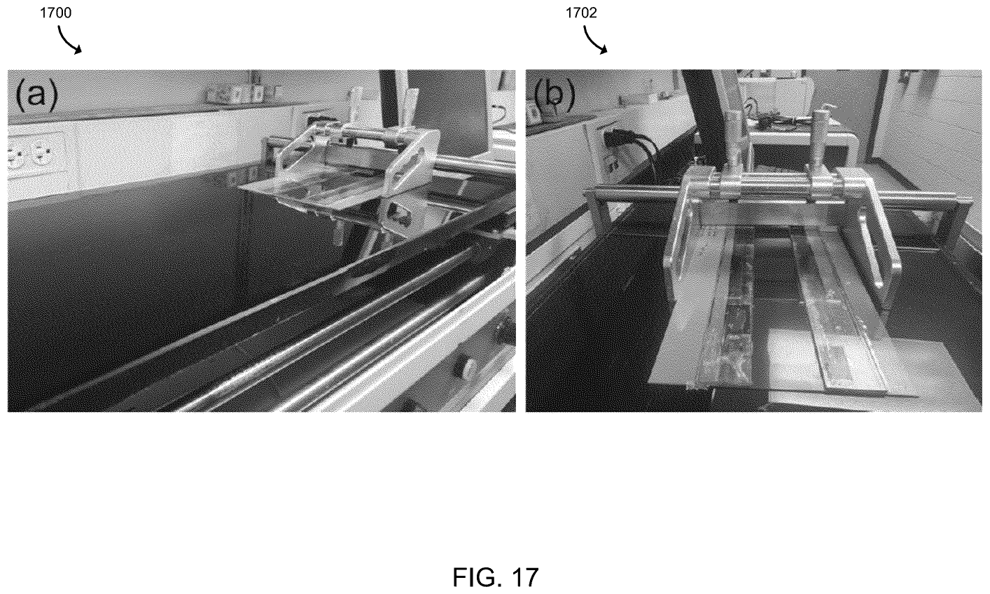

With increasing concentration, the aqueous CNC dispersions exhibited the expected lyotropic liquid crystalline phase behavior, as represented in FIG. 16. In FIG. 16, the images 1600, 1602, 1604, 1606 are transmitted cross-polarized optical microscopy images of aqueous CNC dispersions. Specifically, the image 1600 represents isotropic (1.5 wt %/0.9 vol %, no areas of birefringence). The image 1602 represents biphasic (3.5 wt %/2.2 vol %, both isotropic and ordered domains). Further, the image 1604 represents liquid crystal (5.0 wt %/3.2 vol %, completely birefringent) and the image 1606 represents a gel (5.3 wt %/3.3 vol %, paint texture) phase. The scale bar represents 50 μm. For CNCs, a liquid crystalline dispersion concentration of 3.2 vol % (5.0 wt %) was chosen for film preparation to increase the amount of alignment in the final film. However, the CNC-APTES dispersions did not exhibit liquid crystalline phase behavior at any concentration. Moreover, they appeared more viscous than an equivalent concentration of CNC. This limited the range of concentrations that could be cast into films. Based on processing constraints, a concentration of 1.8 vol % (2.8 wt %) CNC-APTES was chosen for film preparation. All films were shear cast at 15 s⁻¹ onto polyester film using a Gradco doctor blade film coater. Referring to FIG. 17, image 1700 represents a MSK-AFA-II automatic thick film coater (MTI corporation) and image 1702 represents a Gradco film applicator on a polyester substrate. To retain the same amount of CNC in the dried film, the films' wet thickness was 1524 and 3050 μm for CNC and CNC-APTES, respectively. All films were dried at 40° C. for an hour to accelerate gelation and reduce CNC rotational relaxation prior to vitrification. The films were further dried overnight at 25° C.

Cross-polarized optical microscopy and optical contrast measurements were used to compare the degree of nanocrystal alignment in the dried films. Optical contrast, OC, was determined based on the overall intensity of representative images (4908×3264 pixels, 20× magnification, minimum 15 spots) using Equation 3, shown below, in which Iₘₐₓ and Iₘᵢₙ are the film intensity with polarizer 45° and 0°, respectively, relative to flow direction.

$$O C = \frac{( {I}_{max} - {I}_{min} )}{( {I}_{max} + {I}_{min} )} \times 100. \qquad ( Equation 3 )$$

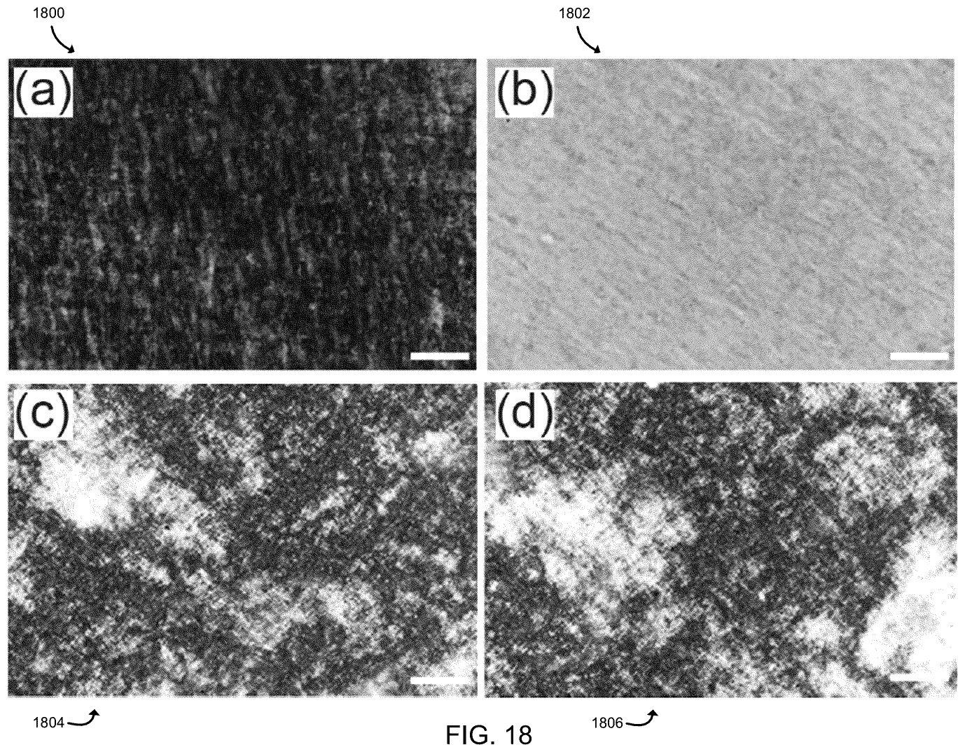

An OC value of 100% indicates complete ordering, whereas negative or 0% OC denotes no significant alignment in the flow direction. Representative cross-polarized optical microscopy images of shear-cast CNCs and CNC-APTES films are shown in the images 1800, 1802, 1804, 1806 of FIG. 18. The images 1800, 1802 correspond with CNC and the images 1804, 1806 correspond with CNC-APTES. The scale bar is 100 μm. These images 1800, 1802, 1804, 1806 correspond to OC=30.5±2.8% for the CNC films and OC=5.5±0.9% for the CNC-APTES films. The higher value for the CNC films is attributed to the presence of significant alignment in the liquid crystalline CNC dispersions compared to the isotropic CNC-APTES dispersions. Even drop-cast liquid crystalline CNC dispersions exhibit ordering. The aggregation resulting from APTES crosslinking and lack of liquid crystallinity due to the modification also impacted the alignment in CNC-APTES film.

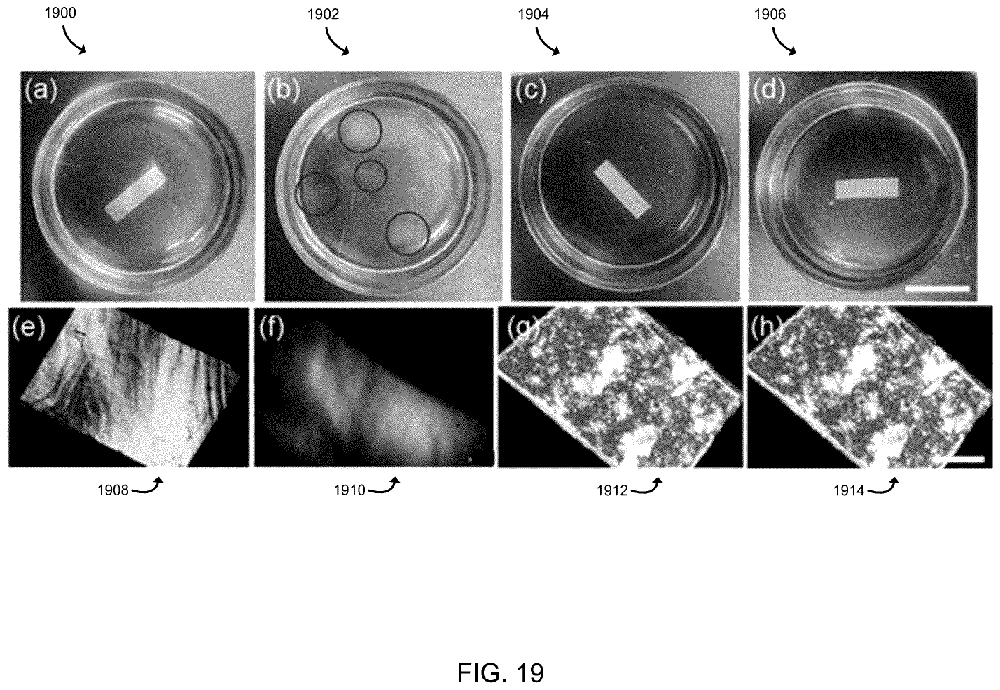

The APTES functionalization did not dramatically impact the films' mechanical properties, but had a profound impact on their contact angle and hydrolytic stability. The contact angles of the pristine CNC films were 70°±7° and 93°±4° for the CNC-APTES films. FIG. 19 represents structural stability of CNC and CNC-APTES films in water. Specifically, image 1900 represents CNC film in water at t=0 hour and image 1902 illustrates CNC film in water at t=2 hours. Image 1904 represents CNC-APTES film in water at t=0 hours and image 1906 represents CNC-APTES film in water at t>36 hours. The scale bar is 20 mm for images 1900, 1902, 1904, and 1906. Images 1908, 1910, 1912, 1914 represent microscopic observations of structural integrity of the films. Specifically, image 1908 depicts the CNC film in water at t=0 minutes, the image 1910 depicts the CNC film at t=15 minutes, the image 1912 illustrates CNC-APTES film in water at t=0 minutes and the image 1914 represents CNC-APTES in the water at t=15 minutes. The scale bar for the image 1908, 1910, 1912, 1914 is 100 μm.

The images 1900 and 1902 show that the CNC films immersed in water disintegrated to form cloudy, hazy, gelatinous regions two hours after immersion into the water. After five hours, even these regions had dispersed. Although APTES' polar amine group is hydrophilic, silylation of the CNC hydroxyl groups resulted in the CNC-APTES films having significantly greater hydrolytic stability. Even after three days, the CNC-APTES films retained their shape. It is noted that after several hours, they did become softer and were challenging to remove from the bath without breaking due to the surface tension of the water. Cross-polarized optical microscopy was used to gain more insight into the temporal changes in the films' structures. Images 1908, 1910 show that the CNC film lost some of its birefringence and changed in shape after a mere 15 minutes. After 20 minutes, this progressed to them becoming completely isotropic. In contrast, images 1912, 1914 show that the CNC-APTES films did not undergo any noticeable changes in 15 minutes.

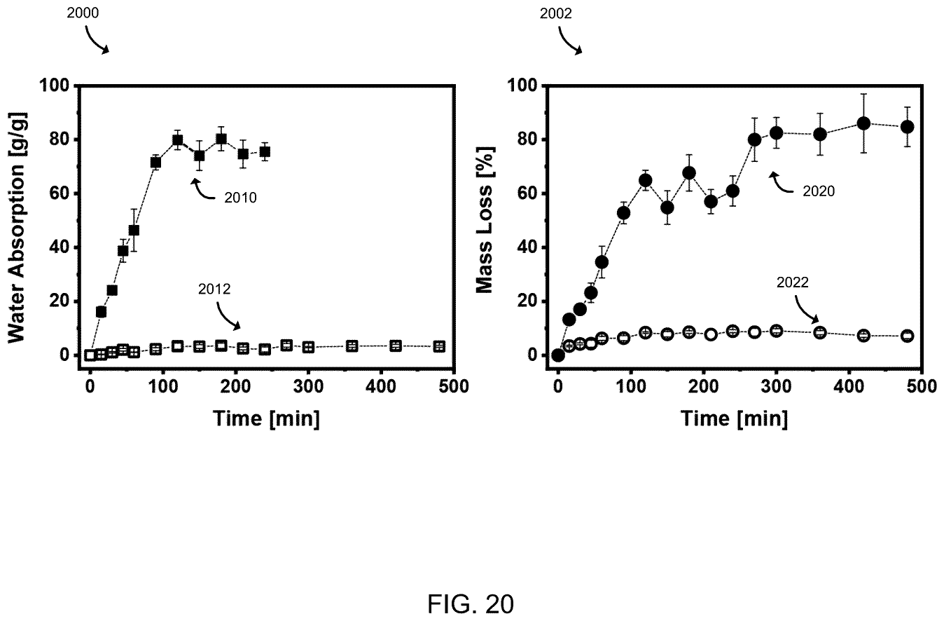

To better quantify the films' water uptake and disintegration, hydrolytic stability tests were performed for different time intervals. The water absorption of each type of film was measured over four hours by removing samples and measuring their mass before and after drying. Referring now to FIG. 20, which represents the hydrolytic stability of CNC and CNC-APTES films, the graph 2000 shows time-dependent change in water update of 10 mm×10 mm films placed in strainers. The plot 2010 represents the CNCs while the plot 2012 represents CNC-APTES. The graph 2002 represents time-dependent change in mass loss of 10 mm×10 mm films placed in strainers, with the plot 2020 representing the CNCs and the plot 2022 representing CNC-APTES. The error bar is based on standard error (n=3). The error bars are smaller than the data points for CNC-APTES.

As shown in the graph 2000 of FIG. 20, the CNC films' water absorption increased with time until a plateau of approximately 72 g water/g solid was obtained after two hours. By this point, the films had transformed into a gel constrained in the strainer. After four hours, no further data was reported as the residual material would flow out of the strainer upon removal from the bath. With APTES modification, the water uptake was limited to 3.7 g water/g solid mass even after four hours, and the films retained their rectangular shape. Film disintegration (loss of CNC to the water bath) was quantified based on the mass of dried material remaining in the strainer relative to the initial film mass, as shown in the graph 2002 of FIG. 20. Consistent with visual observation, the CNC films lost more than half their mass in less than two hours. The remaining gelatinous material continued to lose CNC, resulting in approximately 80% of the mass being lost within four hours. In contrast, the CNC-APTES mass loss showed an initial increase and then remained steady at less than 10% throughout the 4-hour test.

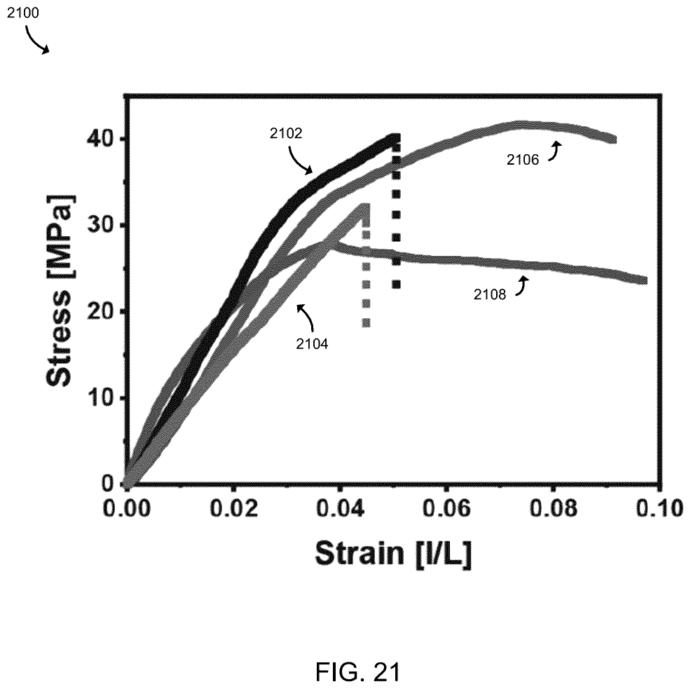

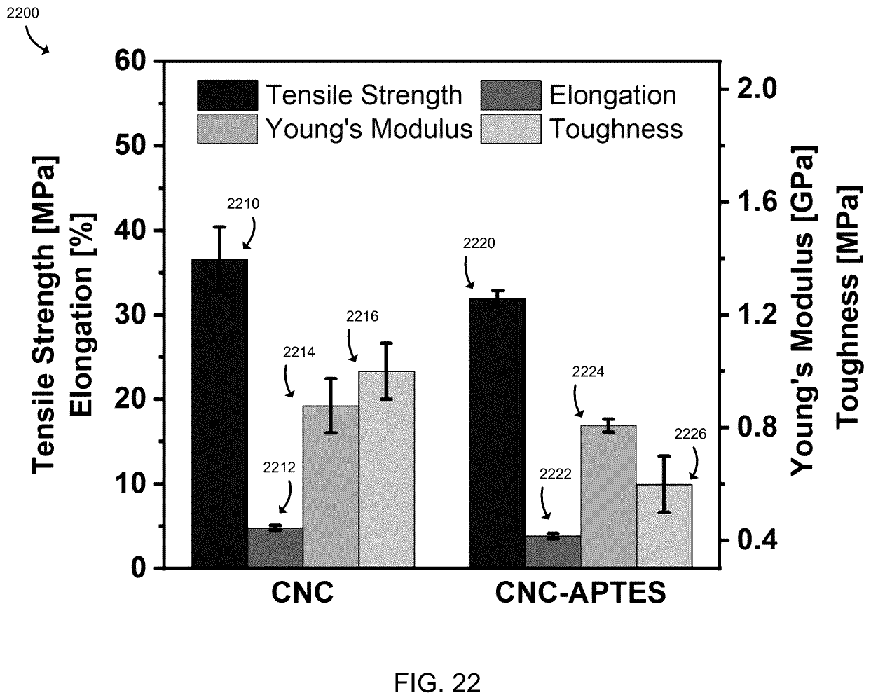

Mechanical properties of shear cast CNC and CNC-APTES films were evaluated using the stress strain graph 2100 shown in FIG. 21, in which the plot 2102 represents CNC before immersion in water, plot 2104 represents CNC-APTES before immersion, plot 2106 represents CNC-APTES after five minutes of water immersion, and plot 2108 represents CNC-APTES after 120 minutes of immersion. The graph 2200 of FIG. 22 represents a comparison of mechanical properties, including tensile strength, elongation, Young's modulus, and toughness of sheared 15 s⁻¹ CNC and CNC-APTES films. Specifically, in FIG. 22, the bar 2210 represents the tensile strength of CNC, the bar 2212 represents the elongation of CNC, the bar 2214 represents the Young's modulus of CNC, and the bar 2216 represents the toughness of CNC. The bar 2220 represents the tensile strength of CNC-APTES, the bar 2222 represents the elongation of CNC-APTES, the bar 2224 represents the Young's modulus of CNC-APTES, and the bar 2226 represents the toughness of CNC-APTES. The error bars represent standard error (n=7). FIG. 22 shows that APTES modification did not significantly affect most of the films' mechanical properties. This was confirmed using two-sample t-tests with unequal variance. There was no statistically significant difference between the measured average tensile strengths of the CNC and CNC-APTES films (36.6±3.8 MPa and 31.9±0.9 MPa, respectively). The average Young's moduli were nearly identical (0.9±0.1 and 0.8±0.0 GPa for CNC and CNC-APTES films, respectively). These values were calculated from the initial linear region of the stress strain plots of FIG. 21. The CNC films had a slightly higher average elongation at break than the CNC-APTES films (4.8±0.3% and 3.8±0.3%, respectively, p=0.054). The subtle differences in individual property values resulted in statistically significant differences in the films' toughness. The toughness of the CNC films was 1.0±0.1 MPa compared to 0.6±0.1 MPa for CNC-APTES films (p=0.044). While the presence of APTES on the CNC surface provides the flexibility to dissipate ordering stress, APTES' disruption of CNC-CNC interactions and CNC-APTES aggregation could account for this decrease in toughness. Since only one shear rate was studied, it is not possible to deconvolute the effects of alignment, as measured by optical contrast, from the effects of chemical modification. However, any changes in properties resulting from differences in alignment would likely be limited to the Young's modulus.

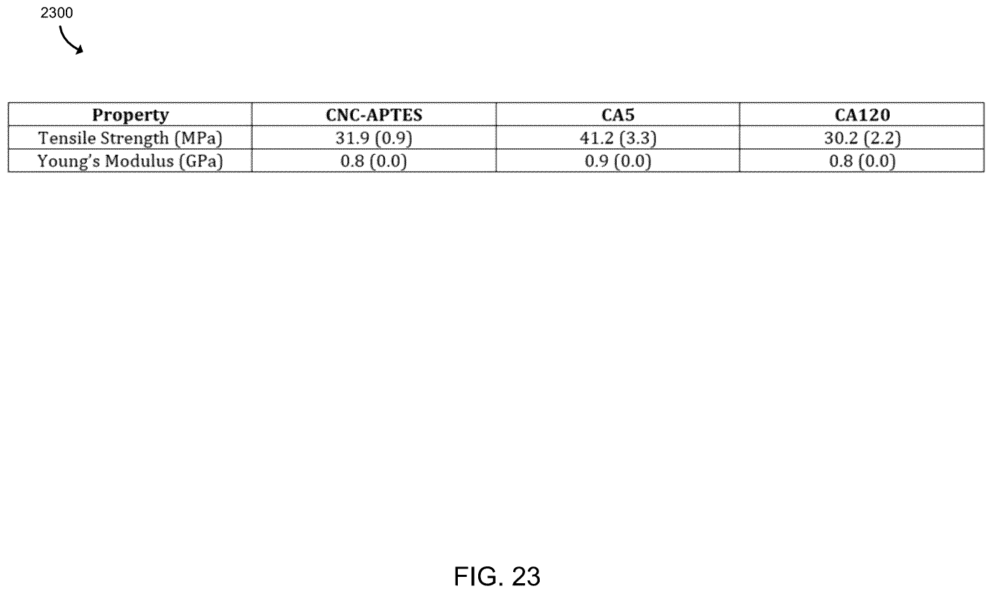

The mechanical properties of CNC films could not be investigated after even brief water immersion due to their rapid mass loss and lack of mechanical integrity during water removal. The mechanical properties of CNC-APTES films were determined after a short (five minute, represented as CA5) and long (120 minute, represented as CA120) period immersion in water, followed by ambient temperature drying. The 5 minute and 120 minute durations were chosen based on the times for non-specific sensing and saturation time in the sensing studies described below. As shown in the table 2300 of FIG. 23 which indicates the mechanical properties of CNC-APTES films before and after water immersion and in which a number in parenthesis represents standard error (n=7), the tensile strengths and Young's moduli of the initial CNC-APTES and CA120 films were identical (p>0.05). Surprisingly, five-minute immersed films CA5 depicted a greater tensile and Young's moduli compared to CNC-APTES and CA120 films. While mechanical properties are considered bulk properties, the impact of water immersion can have an impact on microscale interactions. The 120 minute immersion was likely sufficient time for water diffusion throughout the thickness of the film, resulting in a consistent impact of wetting and drying throughout the films' cross-sections. In contrast, five minute immersion might have only affected the films' surfaces and resulted in something akin to vitrification layers at the top and bottom surfaces. Redrying these layers may have caused film hardening at surfaces, which impacted the overall tensile and Young's moduli of the films. In addition, some of the CA5 (43%) and CA120 (57%) films depicted ductile behavior consisting of necking without fracture, as indicated in FIG. 21. These films were not included in the reported elongation and toughness data. The cause of this behavior and its inconsistency is unknown. However, one possibility is that the possible hydrolysis of APTES converting some Si—O—C to Si—OH, which would enhance hydrogen bonding between both APTES-APTES and CNC-APTES. This could lead to greater elongation of the films due to the sliding of CNCs in hydrogen bonding plane that can exist between two APTES groups as well as between APTES and CNCs. The mass loss and resulting free volume within the films may also have contributed to them becoming more ductile.

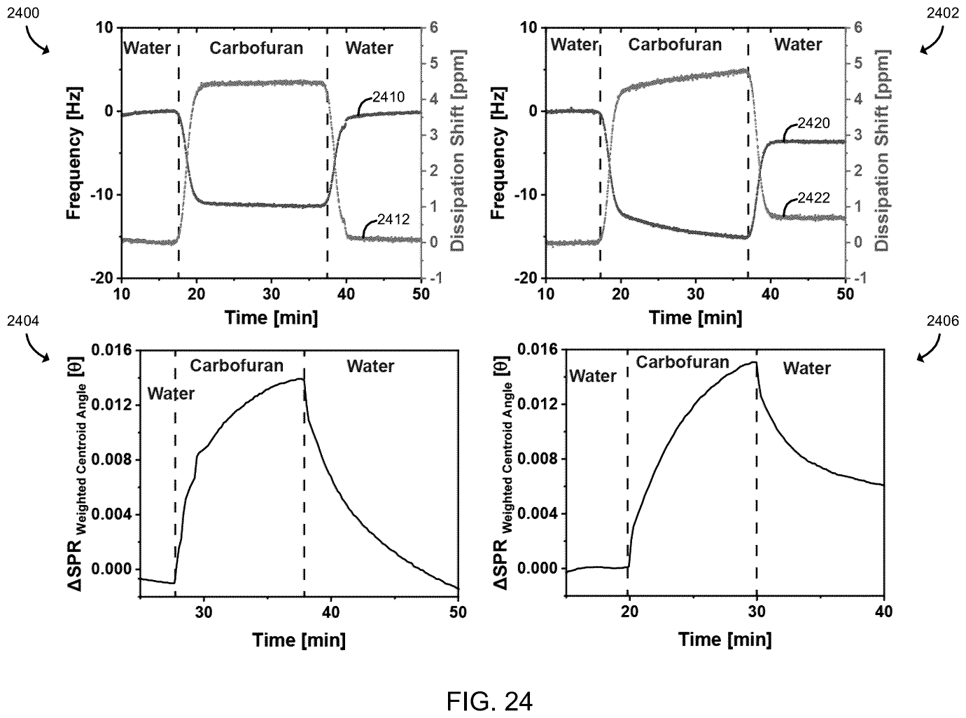

As described above, modified CNCs (e.g., modified with APTES) may be utilized to adsorb molecules in an aqueous medium (e.g., a water-based application). An implementation of the method 100 in which modified CNCs are utilized to adsorb and detect (e.g., sense) molecules of carbofuran using both a QCMD device and SPR device (e.g., in which the modified CNCs are applied as a coating to surfaces of sensor components of the QCMD device and the SPR device) is described below. Carbofuran, like many other carbamates used in agriculture, can be swept away with rainwater water and enter the water cycle. Weak degradability in environmental conditions and high solubility in water has caused carbofuran to be recognized as an emerging contaminant. Two different techniques, quartz crystal microbalance with dissipation monitoring (QCMD) and multiparametric surface plasmon resonance (MP-SPR), were employed to study the interaction of carbofuran with spin coated CNC and CNC-APTES films, as shown in FIG. 24, which includes representative QCMD and SPR sensorgrams of CNC and CNC-APTES coated Au sensors. The sensorgram 2400 relates to QCMD and indicates the interaction of carbofuran (100 ppm) with CNC film. The sensorgram 2402 also relates to QCMD and indicates the interaction of carbofuran (100 ppm) with CNC-APTES film. The plots 2410, 2420 represent frequency and the plots 2412, 2422 represent dissipation. The sensorgram 2404 relates to SPR and indicates the interaction of carbofuran (100 ppm) with CNC film. The sensorgram 2406 also relates to SPR and indicates the interaction of carbofuran (100 ppm) with CNC-APTES film (channel 1, 670 nm laser).

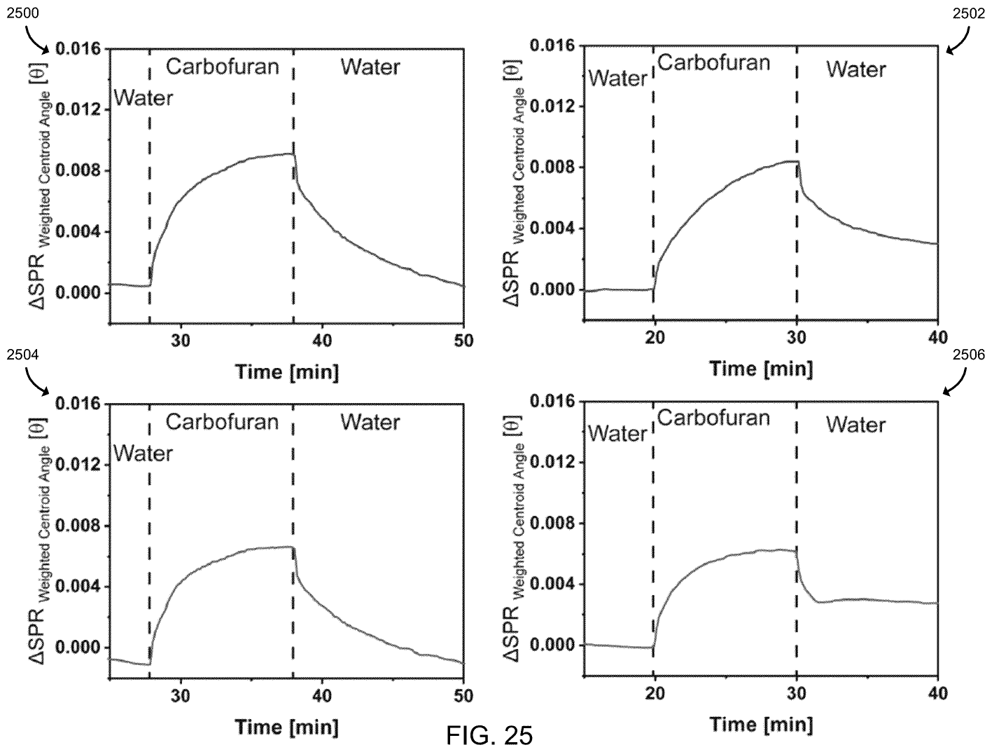

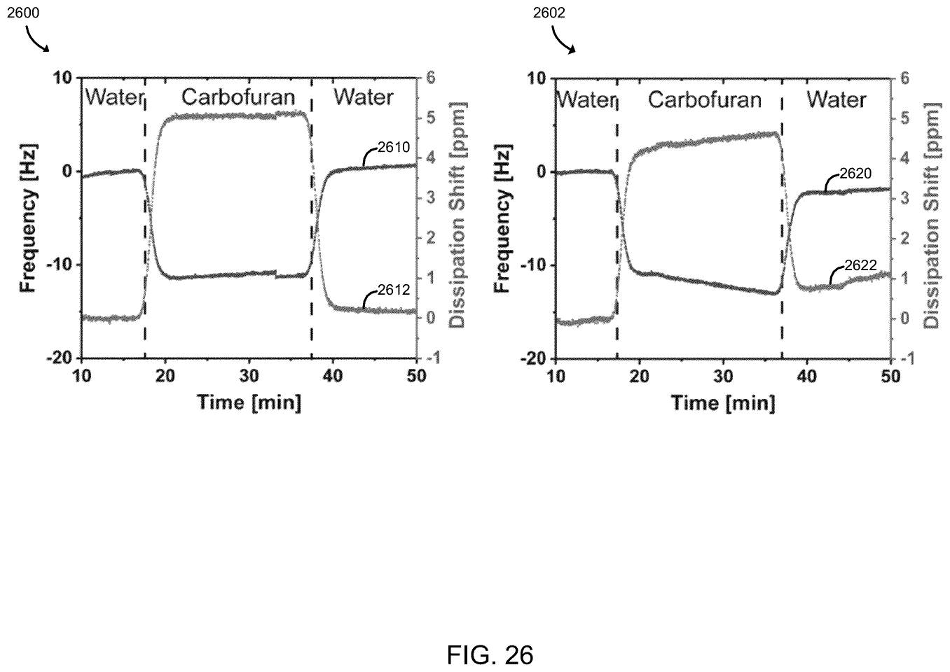

QCMD is a surface technique that simultaneously monitors the adsorption of the molecules based on frequency shift Δf, and energy loss via dissipation shift ΔD. SPR is an optical technique that detects the shift in reflective angle θ due to the change in plasmonic properties. For SPR, two different channels were studied to ensure repeatability, whereas each channel was excited with two different wavelength lasers to excite the plasmon at different levels. FIG. 25 represents additional SPR sensorgrams of CNC and CNC-APTES coated Au sensors. In FIG. 25, the sensorgram 2500 indicates the interaction of carbofuran (100 ppm) with CNC film with channel 1, laser 785 nm. The sensorgram 2504 indicates the interaction of carbofuran with CNC film with channel 2, laser 670 nm. The sensorgram 2502 indicates the interaction of carbofuran (100 ppm) with CNC-APTES film with channel 1, laser 785 and the sensorgram 2506 indicates the interaction of carbofuran with CNC-APTES film with channel 2, laser 670 nm. Referring briefly to FIG. 26, sensorgrams 2600, 2602 of CNC and CNC-APTES coated Au sensors are shown. Specifically, the sensorgram 2600 indicates the interaction of carbofuran (100 ppm) with CNC film and the sensorgram 2602 indicates the interaction of carbofuran (100 ppm) with CNC-APTES film. The plots 2610, 2620 represent frequency and the plots 2612, 2622 represent dissipation.

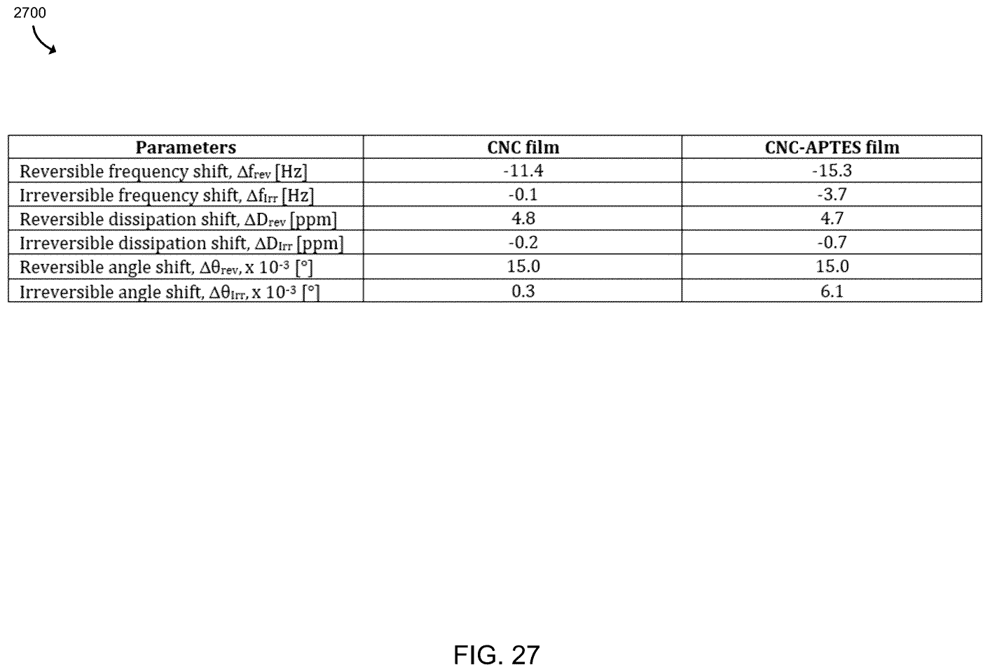

For both methods, ultrapure water flowed over the CNC or CNC-APTES coated sensor until a flat response was observed, indicating the stability of the surface-water interactions. This step was defined as Zone 1. After that, 100 ppm aqueous carbofuran solution was introduced and flowed until achieving a stable response, which resulted in a drop in frequency for QCMD and a positive shift of reflective angle for SPR (Zone 2). Then, in Zone 3, the sensors were flushed with water again to remove loosely bonded carbofuran from the film. The shift of response between Zone 2 and 1 was the reversible attachment of carbofuran, whereas the response shift between Zone 3 and 1 denotes the irreversible attachment of carbofuran onto CNC and CNC-APTES films. The calculated shifts are provided in the table 2700 of FIG. 27, representing nonspecific molecular interaction of carbofuran with CNC and CNC-APTES.

In terms of reversible binding, QCMD showed a higher Δf for CNC-APTES compared to CNC, although no significant difference in Δθ was observed in the MP-SPR measurements. It should be noted that SPR is an optical technique with inherent limitations concerning film thickness. In addition, the shifts in Δθ were different for different lasers (FIG. 24, sensorgrams 2404, 2406, and FIG. 25), which can be attributed to the constant values of each laser (k*dp=1×10⁻⁷ nm/degree for 670 nm and 1.9×10⁻⁷ nm/degree for 785 nm). In Zone 3, the removal of unbound carbofuran results in an increase in f and a decrease in θ. The differences in these values from those in Zone 1 indicate the irreversible adsorption. Neither QCMD nor SPR showed appreciable irreversible attachment of carbofuran to CNC. However, both methods showed irreversible attachment to CNC-APTES with Δf=−3.7 Hz or Δθ=3×10⁻³°, respectively. Changes in dissipation ΔD measured during QCMD provide additional information about the adsorbed layer formation. Increasing dissipation during the flow of carbofuran indicates softer layer formation, but dissipation drops during the flushing with water in Zone 3. The irreversible shift in dissipation with CNC-APTES is significantly higher compared to CNC films, consistent with the change in film properties resulting from the adsorption of carbofuran molecules. The higher affinity of CNC-APTES to carbofuran molecules can be explained in terms of the availability of the end amine (—NH₂) group, which is more favorable than other possible molecular APTES orientations on the modified CNC. The increased irreversible adsorption of carbofuran can be attributed to the electronegative oxygen containing sites of carbofuran interacting with the positive amine end of CNC-APTES being a stronger interaction than with the hydroxyl (—OH) groups readily available on pristine CNCs. It should be noted that the interactions of carbofuran are highly governed by the rotational orientation of nanocrystals, which dictates the exposed functional group at the outer surface, for the spin coated sensors orientation is a function of substrate, rotation speed, time, and dispersion concentration.

In the example implementation above, an aqueous sulfated cellulose nanocrystals (CNCs) dispersion (6.4 wt %/4.1 vol %, CelluForce NCC Dispersion NCV-100 Prod. #C1A20026) with Na+ counter ion was obtained from Celluforce, Montreal, Canada. Ethanol (200 proof, ACS grade), 3-aminopropyl-triethoxy silane (APTES, C₉H₂₃NO₃Si, 99%) and carbofuran (CF, C₁₂H₁₅NO₃, 98%) were purchased from Sigma Aldrich and used as received. Glacial acetic acid (ACS grade) was obtained from VWR International. Densities of 1.6 g/cc for CNCs and CNC-APTES and 1.0 g/cc for water were used in conversions between concentrations by mass and volume. Regarding the synthesis of CNC-APTES (e.g., the modification of CNC with APTES), the as received CNC dispersion was added in APTES plus solvent (water-ethanol, 80/20 v/v) mixture at a mass ratio of 1.8:1 after adjusting the pH to 4.0 with the addition of glacial acetic acid. Running the reaction with higher APTES ratio increased aggregation, most likely due to APTES cross-linking the CNCs. The mixture was tip sonicated for 3 min (90 kJ/g, 750 W, 30%) and then magnetically stirred for 2 hours. Two centrifugation washes (2,200×g, 60 minutes) were conducted to separate the unreacted APTES and solvent. The resulting CNC-APTES sediment varied from 2.0 to 2.2 vol % (3.2 to 3.5 wt %).

The concentration of the as received CNC dispersion was determined using TGA in argon with a 10° C./min ramp to 120° C. followed by an isothermal hold. The initial dispersion was then diluted to the desired concentration with ultrapure water (purified using Labconco Water Pro BT, resistivity 18.2 MΩ cm at 25° C., pH 6.4). The mixture was vortexed for 2 minutes, followed by overnight bottle rolling. The CNC-APTES dispersion was prepared similarly to obtain the desired concentration. The dispersions were allowed to rest for a minimum of 30 minutes to avoid bubbles in the cast films. The shear cast films were prepared on a polyester substrate (0.005 inch thick, Grainger) using a Gradco film applicator and MSK-AFA-II automatic film coater (MTI corporation). The speed was varied based on the wet thickness to achieve a 15 s⁻¹ shear rate. The wet films were dried at 40° C. for an hour (Isotemp Vacuum oven, Fisher Scientific, Model 285A) and then overnight at room temperature (25° C.).

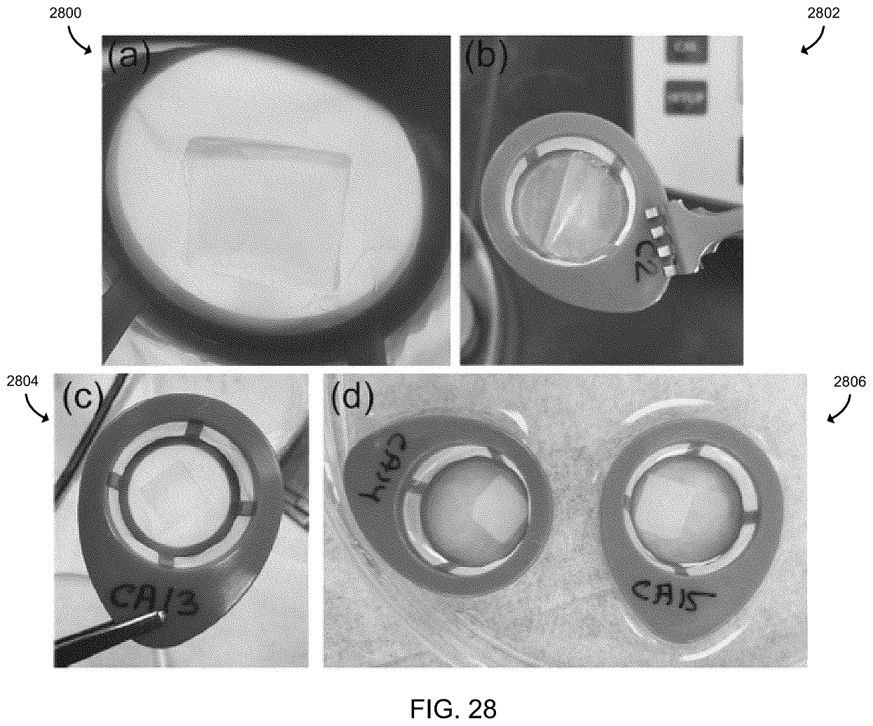

The hydrolytic stability of CNC and CNC-APTES films was evaluated based on the water absorption and mass loss determination. The films were cut into 10 mm×10 mm pieces and placed inside a nylon cell strainer with a 40-micron pore size (VWR international, #76327-098). The strainers were necessary because the CNC films quickly lost mechanical integrity. The masses of films and strainers that had been stored under ambient conditions were recorded as shown in FIG. 28, representing the hydrolytic stability testing of shear cast films. In FIG. 28, the image 2800 represents the swelling of CNC films after 15 minutes, the image 2802 represents the change in shape of CNC films due to aqueous instability, the image 2804 represents a CNC-APTES film 2806 in a 40 μm nylon strainer, and the image 2806 represents CNC-APTES films immersed in water. The films containing strainers were dipped into water for different time intervals. The wet mass was recorded after taking the strainer out of water. The masses of empty strainers that were soaked in water were also recorded to account for moisture on the strainer itself. This value was subtracted from the total wet mass. Again, due to mechanical integrity issues, it was not possible to blot the films to remove free water. Accordingly, the measured values include the mass of water sitting on the surface but not actually physiosorbed. The final mass was noted after drying the wet films overnight at 100° C. Then, the following equations were used to calculate the water absorption and mass loss of the films.

$$Water Absorption = \frac{Wet mass - Final dry mass - water adsorbed on strainer}{Final dry Mass} \qquad ( Equation 4 )$$

$$Mass Loss = \frac{Initial film mass - Final dry}{Initial film mass} \qquad ( Equation 5 )$$

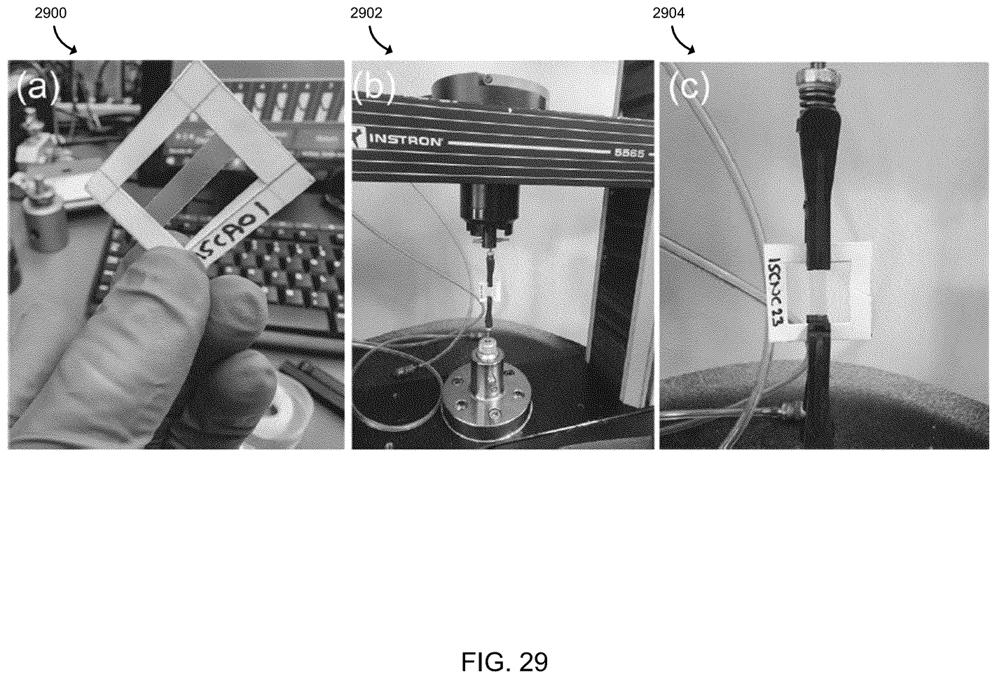

FIG. 29 depicts tensile testing of shear cast films. For tensile testing, the shear cast CNC and CNC-APTES films were cut into 30 mm×5 mm rectangles, with the long axis parallel to the flow direction. The film strips were cut from the center of the dried film to avoid edge effects. The thickness was measured using an electronic digital micrometer (MARATHON part #CO 030025, resolution 2 microns) at 5 different points for each to calculate the average thickness. The films were glued into 30 mm×30 mm paper frames with a border thickness of 5 mm, which resulted in a gauge length of 20 mm for the films, as shown in the image 2900. The frame borders were carefully cut on each side before testing. An Instron 5565 was used to conduct tensile testing using a crosshead speed of 0.5 mm/min and a 100N load cell, as shown in the images 2902, 2904. Average mechanical property measurements were determined on at least seven films, and a two-sample t-test using unequal variance was used to determine if the difference between CNC and CNC-APTES films was statistically significant.

Regarding the devices with which the CNC-APTES was combined, Gold QSensors (QSX301) for QCMD and Gold sensor slides (50 nm Au, 2 nm Cr) for SPR were purchased from Nanoscience Instruments and BioNavis, respectively. All the sensors were washed thoroughly with ethanol and water, followed by 30 min ozone treatment in Novascan PSD series Digital UC Ozone System (Iowa, US). In case of reuse, the sensors were initially cleaned in a solution of NH₄OH, H₂O, and H₂O₂ (at a ratio of 5:1:1, w/w) at 60° C. for 15 min. Sensors were dipped into ultrapure water for 15 min and then cleaned in piranha solution (at a ratio of 3:1 w/w, H₂SO₄ and H₂O₂, respectively) for 1 min, followed by rinse with ultrapure water. The cleaned sensors were coated by immersing in a 0.1 wt % polyethyleneimine solution to create an anchoring layer and then spin coated with 0.1 wt % CNC or CNC-APTES dispersion at 3000 rpm for 1 min using a VTC-110PA tabletop spin coater and dried at 40° C. overnight. A QSense Analyzer from Biolin Scientific (Västra Frölunda, Sweden) was used to follow changes in frequency and dissipation due to molecular interactions between coated film and carbofuran. A similar study was conducted using a MP-SPR Navi 210A VASA (BioNavis Ltd., Tampere, Finland) to measure changes in reflection angle due to the changes in refractive index resulting from adsorption. Experiments were performed with a constant flow rate of 50 μL/min for QCMD and 20 μL/min for SPR at 25° C. The same flow rate was maintained for water and the 100 ppm carbofuran solution.

The low hydrolytic stability of CNC films (or other CNC-based structures, such as coatings, gels, fibers, etc.) has limited their use as sensors or adsorbents requiring water immersion. However, as disclosed herein, CNC-APTES films have considerably greater hydrolytic stability than CNC films. While CNC films immersed in water exhibited notable deterioration in less than 15 min, CNC-APTES films underwent initial moisture adsorption but then retained their shape even after three days, enabling a range of applications involving water immersion for extended periods of time, such as the adsorption and sensing applications described above. Compared to CNC films, CNC-APTES films also have greater adsorption of carbofuran, a model pesticide. As such, CNC-APTES chemistry enables the creation of useful materials (e.g., films, coatings, gels, fibers) that can be used as adsorbents or sensors without additional modification (e.g., based on the methods described above). In addition, and as discussed above, CNC-APTES may be further modified (e.g., with MIPs, GA plus one or more antibodies) to adsorb specific analytes in aqueous mediums, such as biomarkers (e.g., cancer biomarkers).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

1. A method comprising:
obtaining sulfated cellulose nanocrystals (CNCs);
modifying the sulfated CNCs with a silane to obtain modified CNCs, to enable increased hydrolytic stability of an assembly or structure comprised of CNCs; and
using the modified CNCs in a water-based application.

2. The method of claim 1, wherein the assembly or structure is a film, a coating, a gel, or one or more fibers.

3. The method of claim 1, wherein modifying the CNCs with a silane comprises modifying the CNCs with an alkyl silane of formula RSi(X)₃, wherein R is an optionally substituted alkyl group and each X is independently a hydrolysable group.

4. The method of claim 3, wherein modifying the CNCs with the alkyl silane comprises modifying the CNCs with 3-aminopropyl-triethoxysilane (APTES).

5. The method of claim 1, wherein using the modified CNCs comprises using the modified CNCs as a film, a coating, a gel, or one or more fibers to adsorb molecules in an aqueous medium.

6. The method of claim 5, wherein using the modified CNCs comprises using the modified CNCs to filter one or more environmental toxins from the medium.

7. The method of claim 6, wherein using the modified CNCs to filter one or more environmental toxins from the medium comprises using the modified CNCs to filter carbofuran from the medium.

8. The method of claim 5, wherein using the modified CNCs comprises using the modified CNCs to filter one or more allergens from the medium.

9. The method of claim 8, wherein using the modified CNCs to filter one or more allergens from the medium comprises using the modified CNCs to filter β-lactoglobulin from the medium.

10. The method of claim 1, further comprising performing further modification to adjust adsorption characteristics of the modified CNCs including combining the modified CNCs with molecularly imprinted polymers or combining the modified CNCs with glutaric anhydride (GA) and one or more antibodies.

11. The method of claim 1, wherein using the modified CNCs comprises using the modified CNCs to adsorb one or more analytes to be detected.

12. The method of claim 11, wherein using the modified CNCs to adsorb one or more analytes comprises using the modified CNCs to adsorb at least one pesticide identified as a contaminant of emerging concern.

13. The method of claim 11, wherein using the modified CNCs to adsorb one or more analytes to be detected comprises using the modified CNCs to adsorb carbofuran or β-lactoglobulin.

14. The method of claim 11, wherein using the CNCs to adsorb one or more analytes to be detected comprises using the modified CNCs to adsorb one or more biomarkers.

15. A device comprising:
a component with a surface; and
sulfated cellulose nanocrystals (CNCs) modified with a silane to enable increased hydrolytic stability of an assembly or structure comprised of CNCs, wherein the CNCs are connected to or form at least a portion of the surface.

16. The device of claim 15, wherein the modified CNCs are structured as a film, a coating, a gel, or one or more fibers.

17. The device of claim 15, wherein the component is a sensor for detecting one or more analytes, an environmental toxin, or an allergen.

18. The device of claim 17, wherein the component is a sensor for detecting carbofuran or β-lactoglobulin.

19. The device of claim 14, wherein the device is a microdevice, a quartz crystal microbalance with dissipation (QCMD) device, or a surface plasmon resonance (SPR) device.

20. A method comprising:
obtaining a device that includes sulfated cellulose nanocrystals (CNCs) modified with a silane to enable increased hydrolytic stability of an assembly or structure comprised of the CNCs; and
utilizing the device in a water-based application.
